(19) United States
(12) Patent Application Publication
(10) Pub. No.: US 2013/0091214 A1
(43) Pub. Date: Apr. 11, 2013

(54) MEDIA SOCIAL NETWORK

(71) Applicants: Marcus C. Kellerman, San Diego, CA (US); Wael W. Diab, San Francisco, CA (US); William S. Bunch, Menlo Park, CA (US); Sherman (Xuemin) Chen, Rancho Santa Fe, CA (US); Yasantha N. Rajakarunanayake, San Ramon, CA (US); James D. Bennett, Hroznetin (CZ)

(72) Inventors: Marcus C. Kellerman, San Diego, CA (US); Wael W. Diab, San Francisco, CA (US); William S. Bunch, Menlo Park, CA (US); Sherman (Xuemin) Chen, Rancho Santa Fe, CA (US); Yasantha N. Rajakarunanayake, San Ramon, CA (US); James D. Bennett, Hroznetin (CZ)

(73) Assignee: BROADCOM CORPORATION, Irvine, CA (US)

(21) Appl. No.: 13/485,870

(22) Filed: May 31, 2012

Related U.S. Application Data
(60) Provisional application No. 61/545,147, filed on Oct. 8, 2011.

(51) Int. Cl. G06F 15/16

(52) U.S. Cl. 709/204

(57) ABSTRACT

A social networking system enables sharing of content between various members, devices, infrastructures, and the like based upon membership in a social network (SNET group). Content can be protected by limiting access to the content to members of an SNET group, members associated with various devices docked to the SNET group, and the like. Joint access of content by various members of an SNET group can be managed to ensure synchronized access of content and interactions between SNET accessing group members. Instances of a content item can be distributed to multiple destination devices associated with an SNET group, where various instances are transcoded to accommodate varying capabilities and characteristics of various communication pathways and the destination devices and ensure synchronized access of the content item by the multiple destination devices. Interactions between members of an SNET group can be managed to leverage links to other SNET groups.

### CROSS REFERENCE TO RELATED PATENTS/PATENT APPLICATIONS

### Provisional Priority Claim

The present U.S. Utility patent application claims priority pursuant to 35 U.S.C. §119(e) to the following U.S. Provisional patent application which is hereby incorporated herein by reference in its entirety and made part of the present U.S. Utility patent application for all purposes:
1. U.S. Provisional Patent Application Ser. No. 61/545,147, entitled “Social Network Device Memberships and Resource Allocation,” (Attorney Docket No. BP23771), filed Oct. 8, 2011, pending.

### INCORPORATION BY REFERENCE

The following U.S. Utility patent applications are hereby incorporated herein by reference in their entirety and made part of the present U.S. Utility patent application for all purposes:
1. U.S. application Ser. No. 13/331,449, filed Dec. 20, 2011, and entitled, “Bridged Control of Multiple Media Devices via a Selected User Interface in a Wireless Media Network,” (Attorney Docket No. BP22769);
2. U.S. application Ser. No. 13/342,301, filed Jan. 3, 2012, and entitled, “Social Network Device Memberships and Applications,” (Attorney Docket No. BP23771);
3. U.S. application Ser. No. 13/440,834, filed Apr. 5, 2012, and entitled, “Social Network Device Communication Resource Allocation,” (Attorney Docket No. BP23771.1);
4. U.S. application Ser. No. 13/408,986, filed Feb. 29, 2012, and entitled, “Social Device Resource Management,” (Attorney Docket No. BP23776);
5. U.S. application Ser. No. 13/408,991, filed Feb. 29, 2012, and entitled, “Social Device Anonymity via Full, Content Only, and Functionally Access Views,” (Attorney Docket No. BP23776.1);
6. U.S. application Ser. No. 13/396,449, filed Mar. 30, 2012, and entitled, “Social Device Security in a Social Network,” (Attorney Docket No. BP23805);
7. U.S. application Ser. No. 13/436,085, filed Mar. 30, 2012, and entitled, “Content Security in a Social Network,” (Attorney Docket No. BP23805.1);
8. U.S. application Ser. No. 13/337,495, filed Dec. 27, 2011, and entitled, “Advanced Content Hosting,” (Attorney Docket No. BP23823); and
9. U.S. application Ser. No. 13/351,822, filed Jan. 17, 2012, and entitled, “Ad Hoc Social Networking,” (Attorney Docket No. BP23785).

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

1. Field of the Invention

This invention relates generally to content that is stored or distributed in the context of a social network, and more particularly to content sharing and security in a social network.

2. Related Art

The popularity and growth of social network sites and services has increased dramatically over the last few years. Present social network sites include Facebook, Google+, Twitter, MySpace, YouTube, LinkedIn, Flicker, Jaiku, MYUBO, Bebo and the like. Such social networking (SNET) sites are typically web-based and organized around user profiles and/or collections of content accessible by members of the network. Membership in such social networks is comprised of individuals, or groupings of individuals, who are generally represented by profile pages and permitted to interact as determined by the social networking service.

In many popular social networks, especially profile-focused social networks, activity centers on web pages or social spaces that enable members to view profiles, communicate and share activities, interests, opinions, status updates, audio/video content, etc., across networks of contacts. Social networking services might also allow members to track certain activities of other members of the social network, collaborate, locate and connect with existing friends, former acquaintances and colleagues, and establish new connections with other members.

Individual members typically connect to social networking services through existing web-based platforms via a computing device, tablet or smartphone. Members often share a common bond, social status, or geographic or cultural connection with their respective contacts. Smartphone and games-based mobile social networking services are examples of rapidly developing areas.

While social networks are usually comprised of individuals, members might also include companies, restaurants, political parties and event profiles that are represented in a like manner to human members (e.g., profile pages accessible by members of a social network). Individual members typically connect to social networking services through existing web-based platforms via a computing device and/or mobile smartphone. Smartphone and games-based mobile social networking services are other rapidly developing areas.

In so-called “cloud” computing, computing tasks are performed on remote computers/servers, which are typically accessed via Internet connections. One benefit of cloud computing is that may reduce the relative processing and storage capabilities required by user devices (e.g., a cloud computer may load a webpage accessed by a tablet device and communicate only required information back to the tablet). Accordingly, recent years have witnessed an ever-growing amount of content and application software being migrated from local or on-site storage to cloud-based data storage and management. Such software functionality/services and content are typically available on-demand via (virtualized) network infrastructures.

As the use of social networks continues to proliferate, the limitations of sharing of content, also referred to herein as “content items”, “instances of content items”, and the like, software functionality/services and security measures used in the context of social networks become more of a concern. As a result, it becomes apparent that current content, software functionality/services and security measures are less than perfect.

### BRIEF DESCRIPTION OF THE DRAWINGS

FIG. 1 illustrates a schematic block diagram of a social networking environment according to various embodiments of the disclosure;

FIG. 2 illustrates a schematic block diagram of a social networking environment according to various embodiments of the disclosure;

FIG. 3 illustrates adaptive transcoding of various input signals according to various embodiments of the disclosure;

FIG. 4 is a schematic block diagram illustrating adaptive communication resource aggregation in accordance with an embodiment of the present invention;

FIG. 5 is a functional block diagram of a local or cloud-based social network gateway/access point in accordance with an embodiment of the present invention;

FIG. 6 is a logic diagram of a method for allocating communication resources of social network group/sub-group in accordance with an embodiment of the present invention.

FIG. 7 illustrates a schematic block diagram of a social networking environment according to various embodiments of the disclosure;

FIG. 8 illustrates a schematic block diagram of a social networking environment according to various embodiments of the disclosure;

FIG. 9 illustrates a representative view according to various embodiments of the disclosure;

FIG. 10 illustrates a flowchart according to various embodiments of the disclosure;

FIG. 11 illustrates a flowchart according to various embodiments of the disclosure;

FIG. 12 illustrates a flowchart according to various embodiments of the disclosure;

FIG. 13 illustrates a flowchart according to various embodiments of the disclosure;

FIG. 14 illustrates a schematic block diagram of a social networking environment according to various embodiments of the disclosure;

FIG. 15 is a block diagram illustrating an SNET host processing system and circuitry controlling the secure distribution of content according to various embodiments of the disclosure;

FIG. 16 is a block diagram illustrating a social device having both secure and unsecure portions according to various embodiments of the disclosure;

FIG. 17 illustrates a social network group comprising social devices in accordance with various embodiments of the disclosure;

FIG. 18 is a schematic block diagram of an embodiment of a social device or server comprising functionality operable to support social network group/sub-group membership and content protection security measures in accordance with the disclosure; and

FIG. 19 is a diagram illustrating establishing and verifying levels of trust and trust chain links according to various implementations of the present disclosure.

### DETAILED DESCRIPTION OF THE INVENTION

Docking one or more devices allows them to share limited or full access to at least some resources, sometimes referred to hereinafter as consumption of some resources, available via one or more social network (SNET) systems, infrastructures, groups, some combination thereof, or the like to which the one or more devices, processing systems, and the like are docked. The security of each access can be implemented by using separate security secrets, for example public or private keys, for communication between SNET group members, by using authentication and trust techniques, or both.

Various SNET implementations described herein are implemented using a self-monitoring, secure social network infrastructure made up of social devices, processing systems, and the like that work together to manage full or partial sharing of content. The security characteristics of processing systems, devices, members, services, requestors, destinations, presentation pathways, connections, and the like can be determined and used to implement and enforce SNET security. For example, challenges to communication devices included in a presentation pathway can be used ensure continued security of a communication pathway. Security characteristics include, but are not limited to, hardware and software capabilities related to secure storage, communication, and execution of digital rights management (DRM) protected content, trust and authentication levels, associations with other devices and members, and the like.

Some such SNETs are divided into one or more groups, sometimes referred to herein as SNET groups, each of which can implement the same or varying levels of content security as other groups within the same SNET. The level of security applied to items or instances of content can be selected based on, among other things, a status of a requestor, a status of a requested destination device, preferences associated with the content requested, SNET group preferences, security, and trust requirements, satisfaction of authentication requirements, depending on any particular and trust procedures, parameters, protocols, and preferences. The level of protection applied to any particular content can be re-evaluated over time based on the same or similar considerations used in establishing an initial determination.

The status of a requestor can depend on, among other things, whether or not the requestor is a member of the same SNET or SNET group from which the requested content is being provided, results of an authentication challenge, a trust level assigned to the requestor, and a location of the requestor. Membership or other content access rights can be re-evaluated over time.

Various trust and authentication techniques described herein can be implemented on an individual member or device basis, on a SNET group basis, or a combination thereof. These trust and authentication techniques allow SNET members to evaluate the likelihood that other SNET members have been authenticated, assess the likelihood that another SNET member will provide an advertised service at a level of quality advertised, and to determine whether or not a particular SNET member can be trusted or relied upon. Generally, although not always, members having similar levels of trust with respect to authentication can be included in the same SNET group, thereby allowing other members of the same SNET group to rely on SNET group membership as a proxy for an authentication trust level. In some such embodiments, members of a particular SNET group may have common, or similar, levels of trust with regards to authentication, and different levels of trust with respect to advertised services, information accuracy, or the like. SNET trust and authentication can also include providing the ability to reevaluate and retract some or all rights, at any time, to particular content on an individual, device and SNET group level.

SNET members, docked devices, and SNET services, can be associated with more than one SNET group, and may also be associated with multiple SNET groups, SNETs, and the like. For example, a single content delivery service can be used by multiple different SNETs or SNET groups, or a single device storing one or more instances of a content item can be docked to multiple different SNETs or SNET groups. To facilitate secure transmission of protected content within and between the different SNETs and SNET groups to which a single device or service belongs, a device can store different keys for each of SNET group and SNET in separate, restricted portions of memory. In addition, content offered by a service or stored on a member or docked device can be maintained in restricted device memory, content storage devices, or the like which can help to limit unauthorized access to individual content instances based on rules, preferences, and security requirements associated with the different SNETs or SNET groups.

Before responding to a request to transfer content to a destination device, the destination device, the requestor, or both can be subjected to trust verification. A level of trust associated with a particular member, device, SNET group, or other SNET, can in some cases be adaptive, that is the trust level can vary over time based on factors such as previous interactions with other SNET members, interactions with trusted third party sources, the passage of time since a previous authentication procedure, or the like.

Other content security measures include distributing among SNET group members and devices currently docked in the SNET group, information such as device, requestor, and content blacklists or whitelists, encoding algorithm selection information, digital rights management (DRM) keys, device capabilities, communication pathway characteristics, user preferences, and the like. In some instances, before protected content is delivered to a destination device, the destination device can be required to dock with an SNET or SNET group, or become an SNET group member. Various embodiments also employ DRM chaining, group broadcasting, and DRM redirection.

When transmitting content between SNET groups, between an SNET group and a third-party content provider, or the like, group-level authorization can be checked to determine if the SNET group to which the content is being sent is authorized to receive the content. For example, a content preference or parameter setting can be used to indicate that members and docked devices of selected SNET groups are designated as authorized to receive some or all content based solely on authenticated membership, or docking, in one of the selected SNET groups. A check can also be made to determine if the member attempting to transmit the content is authorized to do so. This can help to prevent a device from acting as an unauthorized proxy for requests from non-members, or to non-member devices. Content can also be tagged to prevent distribution by unauthorized proxies. In some embodiments, SNET and SNET group authorization checks can be used to supplement or replace other digital rights management (DRM) restrictions, content protection processes, or the like.

An SNET can also include an underlying billing/accounting infrastructure, which provides various content-related billing and accounting functionality including, among others: 1) group discounting, which allows members of a given SNET group to consume content at a discounted rate, as compared to the cost associated with each member of the SNET group consuming the content individually; 2) group caching which allows a single instance of content cached in a social device accessible to an SNET group to be accessed and shared by multiple SNET group members; and 3) group billing, which facilitates the sharing and distribution of content costs among members of an SNET group.

In some embodiments, DRM restrictions can authorize access to one or more instances of a content item based upon membership to a selected SNET group. For example, a member of an SNET group can purchase a license to access instances of a content item from a service, where the license authorizes one or more other members of the SNET group to access one or more instances of the content item based upon membership in the SNET group. Such authorized access can include access to the content item via interaction with a content source, one or more instances of the content item stored on a content storage system docked to the SNET group, some combination thereof, or the like. For example, where an SNET member purchases a license to access a content item, downloads an instance of the content item, and stores the instance in a content storage system docked to the SNET group, other members of the SNET group can access the instance, either by interacting with the content storage system directly via a network, indirectly via interaction with the SNET group to which it is docked, some combination thereof, or the like.

In some embodiments, a DRM restriction authorizes multicasting of a content item based upon membership in an SNET group. For example, where a content source provides an instance of a content item to a member of an SNET group, a DRM restriction associated with the content item may authorize copying and distribution of various instances of the content item to various content storage systems, devices, processing systems, or the like based upon association with the SNET group. The DRM restriction may set a maximum number of instances that may be copied, maximum number of accesses of each instance, maximum number of access of all instances, some combination thereof, or the like. Multicasting can be managed by a processing system supporting at least some of an SNET group, one or more devices docked to the SNET group, a service associated with the SNET group, one or more media management elements (MME) that are encompassed by one or more instances of same, some combination thereof, or the like.

Members of an SNET group can, in some embodiments, access various instances of content items at a discounted rate based upon membership in an SNET group in which another one or more members of the SNET group has access to an instance of the content item. Discounted access to content items can be managed by one or more devices docked to the SNET group, a processing system supporting at least some of the SNET group, a service linked associated with the SNET group, some combination thereof, or the like. For example, where a member of an SNET group accesses an instance of a content item from a content source and stores the instance on a content storage system (e.g., on a cloud storage, a storage device, or the like) docked to the SNET group, another member of the SNET group may be authorized by a processing system supporting the SNET group to purchase a license to access an instance the content item at a discounted rate by accessing the instance stored on the content storage system, rather than accessing an instance from the content source.

Various SNETs also provide social interaction functionality and resource management. Social interaction support includes providing infrastructure, interfaces, and communication channels that provide a way to interact socially in relation to content sharing, e.g. via comments, forum access, tweets, postings, pinning, ratings, descriptions, live-video pop-up, chat windows, or other interactions. The social interaction functionality provides human members a mechanism for enriching the content consumption and sharing experience before, during, and after such consumption. In some embodiments, members can develop supplementary data related to at least part of a content item being accessed by a member and share the data with other members, services associated with an SNET group, or the like. For example, an SNET group member watching a film accessed via the SNET group may create commentary for one or more scenes in the film, mark some scenes with tabs to be “jumped” to by others, mark some scenes with tabs to be “skipped” by others, or the like. Supplementary data can be developed by a member during the member's accessing of a content item, substantially concurrently with the member's accessing of the content item, or the like. Substantially concurrent development of supplementary data can include, without limitation, developing supplementary content within a predetermined time period of access of the content item to which the supplementary content is related.

In some embodiments, a member of an SNET group that is accessing a content item may be prompted to develop supplementary data related to the content item. Such a prompt can be delivered via a representative view of at least some part of the SNET group, a representative view that includes a field displaying the content item, or the like. For example, an SNET group member watching a film may be prompted by a field, delivered from a processing system supporting the SNET group, to create commentary regarding the scenes of the film that the member is currently watching. The member may be prompted to develop supplementary data at certain points in accessing the content item, such as partial completion of the access, full completion of the access, upon accessing one or more certain portions of the content item, substantially concurrently with any of the above, or the like. For example, the member may receive a prompt to create commentary at the conclusion of each scene of a film, provide a review and rating of the film within a certain time period of the film's conclusion, provide a review when the member stops watching the film, some combination thereof, or the like. A processing system supporting at least part of an SNET group can monitor what content item a member of the SNET group is accessing through a docked device, or the like, associate supplementary content developed substantially concurrently with the member's access of the content item with the content item, and share indications of the member's accessing of the content items to other members of the SNET group via a real-time feed displayed via a representative view of at least some part of the SNET group. In addition, the processing system can respond to determining what content item the member is accessing by providing prompts for the member to develop supplementary data related to the specific content item the member has accessed.

In some embodiments, supplementary data developed by members can be shared with other members, services, and the like associated with an SNET group. For example, supplementary data related to a film that includes commentary created by an SNET member as the member watches the film may be shared with other SNET group members via a real-time feed displayed to the members via a representative view of at least some part of the SNET group that the members can interact with via a docked device. The supplementary data can also be shared with various services that are associated with the content item, the SNET group, or the like. For example, supplementary data related to a certain content item may be provided, via the SNET group, to a content source that provided the content item. The supplementary data may be provided to an entity associated with the content item. For example, where a media library is associated with an SNET group, and a content item is downloaded from the media library by a member of the SNET group, commentary related to the content item developed by various members of the SNET group can be accessed from the SNET group by some part of the media library, provided to the media library by a processing system supporting at least some part of the SNET group, some combination thereof, or the like. The commentary provided to the media library can be shared with other entities accessing same or similar content items from the media library, advertising services, content providers, or the like. For example, the commentary can be provided to the media library, which in turn makes the commentary available to the corporation that produced the content item, an advertising firm responsible for marketing the content item, or the like. As a result, a producer of content can receive real-time feedback regarding content items provided to those that access (“consume”) the content items. As another example, a content source service can establish an SNET group dedicated to films provided by the content source, and distribute commentary supplementary data developed by members of the SNET group that watch certain films to the producer of the certain films, thereby enabling the SNET group members to provide audience feedback to the producer of the content items.

In some embodiments, advertising services can provide targeted advertisements to various members of an SNET group based, at least in part, upon access of certain content items and interactions between various SNET group members. A processing system supporting an SNET group may track an SNET group member's access of a content item and provide advertisements that are related to a part of the content item that the SNET group member is currently accessing. For example, where an SNET group member is watching a television show, a processing system that tracks the SNET group member's viewing of the show may provide advertisements that are related to aspects of the show including, without limitation, articles of clothing, furniture, related shows, home furnishings, vacations to related locations, or the like.

In some embodiments, advertisements can be provided to an SNET group member based upon the SNET group member's interactions with other SNET members. A processing system supporting at least part of an SNET group may track an SNET group member's accessing of a content item and monitor concurrently developed supplementary data, interactions with other SNET members, and the like for indications that the SNET group member has an interest in some aspect related to the content item that the SNET group member is accessing or has recently accessed. For example, where an SNET group member is watching a television show and creates commentary related to a scene of the television show that remarks on certain articles of clothing displayed in the scene, at least some part of a processing system supporting at least some part of the SNET group may analyze the commentary, identify the remarks on the certain articles of clothing, and provide the SNET group member with advertisements related to the certain articles of clothing. In some embodiments, the advertisements can include links that the SNET group member can interact with to learn more about a certain aspect that the SNET group member is determined to have shown an interest through supplemental data developed by the SNET group member.

Social resource management includes controlling access and access priority over an underlying social resource. For example, an owner of a social device can grant users or groups access to a social resource, function or underlying social element, based on a desired order of priority. This can facilitate load balancing, especially in instances where SNET resources are limited, by providing higher resolution content to higher-priority consumers, by establishing an access queue, or the like. In another example, an owner of a social device can enable use of a transcoder in the device to transcode a content stream to be sent to another device docked with the same SNET group. As used herein, the term “resources” or “social resources” encompasses both device level and social network infrastructure level (cloud/server) devices, services, software and other functionality, and can includes group multicasting functionality, transcoding, payment means, media and other content, content storage/caching/server, trans-cryption, capture elements (microphones, cameras, mechanical mounting controls), and the like.

As used herein, the terms “social network”, “SNET”, “social networking system”, “social networking infrastructure”, and the like, comprise a grouping or social structure of devices and/or individuals, as well as connections, links and interdependencies between such devices and/or individuals. Members or actors (including devices) within or affiliated with an SNET may be referred to herein as “members”, “users”, “membership”, “nodes”, “social devices”, “SNET members”, “SNET membership”, “SNET devices”, “user devices” and/or “modules”. In addition, the terms “social circle”, “social group”, “SNET circle”, “SNET sub-circle”, “SNET group”, and “SNET sub-group” generally denote an SNET that comprises SNET devices and, as contextually appropriate, human SNET members, device SNET members, personal area networks (“PAN”), and the like. As used herein, the term “digital rights management” (DRM), DRM content restrictions, digital rights limitations, and other similar terms are intended to encompass various content protection schemes, standards, protocols, and processes by which various types of data are protected from unauthorized copying and access, including DRM chaining, group broadcasting, and DRM redirection. DRM protected content can include, in addition to pre-recorded content, content being generated and broadcast, multicast, streamed, or other provided live from a social device such as a video recorder, to another device.

The term “trust level” is used to refer to both individual levels of trust, and aggregate or overall levels of trust. For example, an SNET member may have a first level of trust indicating a likelihood that the SNET member is, in fact, who he purports to be. A likelihood that that the SNET member will maintain a promised performance or quality level can be indicated by a second level of trust associated with SNET member, a third level of trust can be used to indicate that the SNET member can provide advertised or promised services, and a fourth level of trust indicating an overall level of trustworthiness. Other types or categories of trust levels can also be implemented according to the teachings set forth herein.

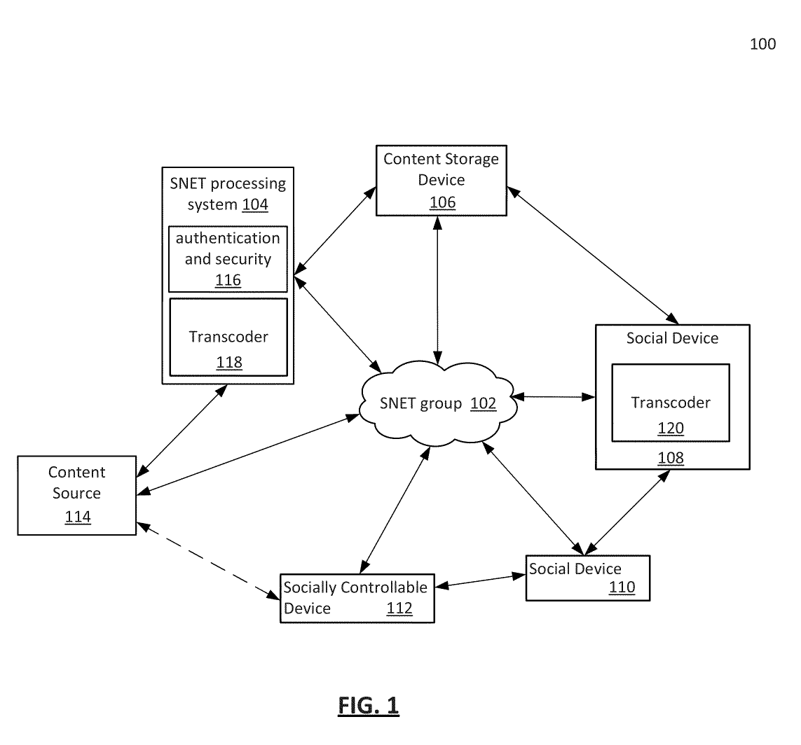

Referring to FIG. 1, a social networking (hereinafter “SNET”) system 100 according to various embodiments is shown. In the illustrated embodiment, SNET system can include an SNET group 102 that is associated with one or more various social devices 108 and 110, socially controllable devices 112, processing systems 104, content storage devices 106, content sources 114, and the like. A processing system can include, without limitation, one or more instances of processing circuitry distributed across one or more server devices, network nodes, some combination thereof, or the like. As shown in the illustrated embodiment, devices, processing systems, and content sources in a SNET system 100 can be docked, associated, joined, and the like with an SNET group 102. At least one process of docking is discussed in further detail in at least U.S. Utility patent application Ser. No. 13/408,986, entitled “Social Device Resource Management,” (Attorney Docket No. BP23776), filed Feb. 29, 2012, incorporated by reference herein in full for all purposes. In some embodiments, a device, processing system, SNET group, or the like docked to another SNET group becomes a member of the SNET group to which it is docked. For example, by docking a social device 108 to an SNET group 102, a user associated with social device 108 can interact with various members, devices, services, applications, and the like associated with the SNET group 102 by interacting with social device 108 docked to the SNET group 102. A user can also dock a socially controllable device 112 to SNET group 102 via interaction with a social device, processing system, some combination thereof, or the like. Members, clients, users, and the like, as referred to herein, can include, without limitation, human members of an SNET or some other network, device members of an SNET or some other network, some combination thereof, and the like.

In many instances, social devices are associated with human members. For example, social device 110 may be a cell phone belonging to a human member, and social device 108 may be a laptop or tablet associated with a human member. Other social devices that may be associated with one or more human members include printers, storage devices, video and audio recording and playback devices, communication devices, and the like.

Continuing with the previous example, a human member can use social device 108 to view a list of files available to members of SNET group 102, where the files may be located on one or more content storage devices 106, social devices, processing systems content sources, socially controllable devices, some combination thereof, or the like. The human member can use social device 108 to request a desired audio-visual file. In some embodiments, selecting one of the available files automatically initiates a request to deliver the selected content to social device 108, or to another selected location or device. For example, where a selected content is stored on content storage device 106, selecting the file automatically initiates a request from social device 108 to processing system 104, content storage device 106, some combination thereof, or the like. In response to receiving the content request from social device 108, processing system 104 can determine the status of social device 108, which can include determining whether social device 108, or a member or SNET group associated with social device 108, has a required DRM license; whether social device 108 is a member of SNET group 102; whether social device 108 is docked to SNET group 102; whether social device 108 has the requisite level of trust to receive the content; whether social device 108 is on a blacklist or a whitelist; whether the member with which social device 108 is associated has a requisite level of trust; whether content sent to social device 108 requires transcoding; whether content delivered to social device 108 is to be tagged to limit redistribution, number of playbacks, or limit a time period in which the content can be played back; whether content is to be watermarked; or otherwise determine a proper level of content protection to apply to the requested content before delivering it to social device 108. In some embodiments, social device 108, simply by virtue of docking or membership in SNET group 102, is presumed to have at least the minimal level of trust required or desired to receive content protected by a first level of content protection.

If social device 108 is authorized and trusted to receive the requested content, processing system 104 determines a level of content protection to implement based on a number of factors that can include, but is not limited to the following: 1) membership or docking in a particular SNET group; 2) membership or docking in a particular SNET; 3) a trust level of either the destination device, a requesting device, or a human member associated with the destination and requesting device; 4) user or content preferences; or 6) DRM or other content licenses associated with the content; or 5) a combination of these. Various DRM or other licenses can include content restrictions and security parameters based on device type, SNET group membership, and various other trust related factors. In some embodiments, the determination can be made based on the encryption or encoding used for the request. By relying on the encryption or encoding used in the request, for example in cases where SNET group 102 employs a public-private key encryption system to encode or encrypt messages between social devices, processing system 104 can be reasonably sure that social device 108 is authorized to receive the requested content.

In various embodiments, including but not limited to those involving the distribution of live content, content security can be set up on a session by session basis, and a single device can have multiple different security and authorization levels. For example, a member may be permitted to view a first live session based on his security characteristics, e.g. a security level, but due to preferences associated with a provider of a second live session, may not be authorized to view the second live session even though the member's security level indicates that he would otherwise be allowed access.

Processing system 104 can initiate delivery of the requested content to social device 108, from one or more various content storage devices 106, content sources 114, other docked devices, some combination thereof, or the like by encoding the content using a shared group key or another encryption and encoding method employed by member devices of SNET group 102. In some cases, social device 108 and content storage device 106 may be located in a demilitarized zone, behind a group-dedicated firewall, or may communicate using a virtual private network service. Using the techniques described herein, content can be distributed within SNET group 102 without undue concern for the content's safety, and with reduced concern about unauthorized reproduction.

Although social devices 108 and 110, socially controllable device 112, content storage device 106, processing system 104, and content source 114 are illustrated as being within SNET group 102, each of the above may be located remotely from each other, in different physical networks or subnets, and use various gateways, routers, switches, and other telecommunication devices, including various wireless communication nodes and devices commonly used for network communications to transfer messages, requests, responses and content among and between members or docked devices.

In some embodiments, processing system 104 utilizes an authorization/verification element 116, which can be located in one or more of a processing system 104, social device, or the like, with information received in a content request, to verify the status and trust of a requestor or destination. In some cases, the request is simply forwarded without processing the contents of the request, while in others the request is at least partially processed by processing system 104 before processing system 104 queries authorization/verification element 116.

Authorization/verification element 116 can, in some instances, be implemented as a service running on a processing system, social device that is a member of SNET group 102, some combination thereof, or the like. Authorization/verification element 116 can also be implemented on an SNET host, but may in some instances be an independent or third party service operating outside of any particular SNET or SNET group. The verification service offered by element 116 is similar to services offered by processing system 104, in that the verification service can potentially be made available to any social device docked within SNET group 106, not just processing system 104.

In some instances, a docked social device, such as social device 110, may request access to content via interaction with SNET group 102. Various docked devices, storage services (e.g., cloud storage), content storage device 106, and the like can store requested content locally, or obtain content from outside of the SNET, for example from a third party content provider, content source 114, or the like. Social device 110 can send a request either directly to content storage device 106 through typical network communication channels, or if social device 110 does not have access to communicate directly with content storage device 106, but does have access to SNET group 102, the social device 110 can send the content request to a processing system 104 supporting, at least in part, the SNET group 102. In response to receiving the request for content, processing system 104 can determine whether or not the requested content is stored local to processing system 104, or whether the content is available from another resource in SNET group 102. Assuming for purposes of this example that that processing system 104 does not store the requested content locally, but can access content storage device 106, processing system 104 can determine whether social device 110 is authorized to receive the requested content. Processing system 104 can also make a determination about whether the requested content is permitted to be provided to social device 110, such as where processing system 104 includes an authentication and security element 116. Processing system 104 can also determine whether or not it is capable of and authorized to make the determination, and if not, forward the request to some other device that is.

If it is determined that the requested content can be provided to social device 110, either directly or through content storage device 106, processing system 104 can implement or initiate appropriate security services and measures to provide one or more of multiple different levels of content protection, based at least in part on the status of the social device 110 requesting the content, or on the status of a destination device

In some cases where processing system 104 determines that it does not store the requested content locally, processing system 104 can send a proxy content request to content storage device 106. The proxy request can include full or partial information about the status of the requestor or destination device, as determined by processing system 104, information about preferences known to processing system 104, and the original content request. Content storage device 106 can then rely partially or entirely on the determinations made by processing system 104, or make its own determinations about whether to grant the original content request from social device 110, and what level of content protection to apply. In some cases, the request can be granted conditionally or partially, for example by providing watermarked or lower quality transcoded content in response to the request.

In some embodiments, some content stored on devices docked to SNET group 102 (e.g., content storage device 106) may be authorized for distribution only within SNET group 102, while other content is authorized for distribution to any group within the SNET. Further restrictions can also be placed on content to prevent redistribution of content outside of SNET group 102, to limit a number of times content can be retransmitted, to adjust the quality of content provided based on group or SNET membership, or otherwise apply different levels of content protection in accordance with content owner, SNET, or content preferences. For example, a particular item of content may be allowed to be distributed to different groups within the SNET, different members of an SNET group, or the like, but other content items may be authorized for distribution even outside an SNET, assuming that a non-SNET requestor device is established as a trusted recipient of the content. This allows, for example, for extended implementation of various DRM protocols and licensing features, which require verification of a recipient device prior to delivering content that recipient device.

Various embodiments can implement a level of protection in which a requesting device must either be docked to a particular social network, docked to a particular group within the social network, or require live that a recipient device check in with a particular SNET or SNET group to obtain live DRM verification prior to receiving requested content. DRM chaining, in which DRM licensing and trust requirements are checked for some or all intermediate nodes along a path used to distribute protected content, can also be used, and in some instances multiple different nodes may be required to obtain live DRM verification prior to being authorized to participate in the content sharing pathway.

The same content can be authorized for distribution at a high quality level within a SNET group 102, but authorized for delivery outside of the SNET group 102 only after first being watermarked or transcoded into a lower quality format. Thus, a single type or item of content may be delivered from content storage device 106 to social device 108 at a first quality level, to a non-group social device using a second quality level, and to a non-SNET requestor device at yet a third, lower quality level. DRM rights restrictions can also be modified by a destination device to support redistribution by the destination device, allowing a destination device to receive content at a first level of content protection, and transmit content at a second level of content protection.

In some embodiments, an instance of a content item to be sent to a device can be transcoded to accommodate various characteristics and capabilities. For example, devices docked to SNET group 102 may provide data regarding audio/video (A/V) capabilities associated with the devices, including, without limitation, A/V formats supported by the device, and the like; communication pathway characteristics, including, without limitation, bitrate, bandwidth, latency, and the like. The capability and configuration data associated with various devices, communication pathways, and the like can be processed by a processing system 104 supporting the SNET group 102, one or more docked devices, or the like. In an example of a transcoding process, a processing system 104 may receive a request, from social device 110, for content that is available to all members of SNET group 102. The processing system 104 may determine that, based upon the capabilities and characteristic data associated with social device 110, various communication pathways between social device 110 and SNET group 102, processing system 104, various other docked devices, and the like, an instance of the content item to be sent to social device 110 must be transcoded to accommodate one or more communication pathway characteristics and characteristics of social device 110. Where a transcoder 118 is local to the processing system 104, the instance can be retrieved from the storage location of the content item, including, without limitation, content storage device 106, a cloud storage system, content source 114, some combination thereof, or the like, the instance can be transcoded, and the transcoded instance can be sent to social device 110 via one or more various communication pathways. In another example, processing system 104 can route an instance of the content item to another docked device 108 that includes a transcoder 120, where the instance is transcoded at the device 108 and routed to social device 110. Transcoding can be adaptive, responsive to variations in one or more communication pathway characteristics, device characteristics, device capabilities, some combination thereof, or the like. In some embodiments, multiple instances of a content item can be distributed simultaneously, with or without transcoding, to various devices docked to SNET group 102.

In addition to, or in place of, watermarking or transcoding content, processing system 104 may select a level of content protection that allows an item of content to be copied a limited number of times, allows content to be accessed or played back for a limited period of time. For example, a first content file can be delivered to social device 108 or social device 110 at a lower resolution without a tag, or at a higher resolution with a tag that limits whether or not the content can be redistributed. Thus, even within SNET group 102, content protection can be implemented to limit the distribution and use of content provided from various sources 114.

Although in many of the examples discussed above, various devices docked to SNET group 102, including, without limitation, content storage device 106, can store requested content locally, various docked devices may obtain content from outside of the SNET, for example from a paid subscription to a cable provider, an Internet provider, media provider, or some other content source 114.

In some embodiments, in cases where a content request asks for content to be delivered to a destination device, such as socially controllable destination device 112, processing system 104 can be used to check authentication and trustworthiness of either the requestor, the destination device, or both the requestor and the destination device. Once the status of the destination device, the requestor, or both has been determined, for example by processing system 104, content storage device 106, an SNET group host, or an SNET host, an appropriate level of content protection can be selected. Various levels of content protection can be applied to content delivered to a device requestor or a destination device based on membership of one or more of the devices in a particular SNET group, based on membership of a device within a particular social network, user preferences, preferences or requirements associated with particular content, or the like.

The level of content protection applied can be refined or limited, based on transmission channel characteristics, as determined by a communication node, the destination device, or the processing system 104. A type of content protection applied can also be restricted based on bandwidth limitations imposed by an SNET host or communication network used to provide the content to a destination device.

In some embodiments, various members of an SNET group can create supplementary data associated with a content item for use by other SNET group members, SNET members, or the like. Supplementary data can include reviews of the content item, marking of certain parts of a content item, selections of “tab” markers for a member accessing the content item to skip to a part of the content item marked by the tab; selections of certain parts of a content item to be “skipped” by certain members; commentary on some or all of a content item, or the like. For example, an SNET group member viewing a film may develop supplementary data including, without limitation, reviews, commentary, ratings, or the like of certain scenes of the film, the film in its entirety, or the like. An SNET group member may mark certain scenes with tabs that a member can utilize to “skip” to certain scenes. Such tabs may be annotated with additional commentary identifying the scene, the purpose of the tab, or the like. For example, an SNET group member watching a football game can, for every touchdown in the game, mark a tab corresponding to the touchdown, along with a short commentary explaining the correspondence, time-shift the tab relative to the game to direct a member to a point in the game preceding the touchdown by a certain period of time, and the like. An SNET group member may mark certain parts of a content item, including, without limitation, scenes of a film, to be skipped. The supplementary data can be developed via interaction by the member with one or more devices. Supplementary data related to a content item can be developed concurrently with access to the content item. For example, a member may mark certain scenes of a film with tabs while the member is watching the film. The supplementary data can be distributed to other members of the SNET group, a node, processing system, content storage device, or the like supporting the SNET group, or the like. Use of the supplementary data may involve selection of one or more of a content item, supplementary content associated with the content item, selecting the content item to be accessed using the supplementary data, in concurrence with the supplementary data, or the like. Other members of the SNET group may be able to view and select the supplementary data by interacting with the SNET group, selecting content items associated with the SNET group for access, some combination thereof, or the like. Various supplementary data can be assigned weights by various SNET group members to indicate greater or less value of the supplementary data. For example, SNET group members may assign weights to a supplementary data that censors certain scenes from a film to indicate that the supplementary data has value to members seeking to censor various undesirable scenes from a presentation of the film.

In some embodiments, various members of an SNET group can assign access rules relating to access of certain content items. Such rules may require that access of certain content items by certain other SNET group members is restricted, must be accessed with certain supplementary data, or the like. For example, an SNET group member may develop supplementary data for a film content item that skips certain undesirable scenes; the SNET group member may assign to other various members of the SNET group, such as various children, access rules that restrict access to the film by the other various members to access with the supplementary data. Other access rules may restrict certain SNET group members from access to certain types of content items. For example, an SNET group member may assign access rules that restrict an SNET group member from being able to access any content items that are action-adventure films. Access rules can be distributed to some or all devices, processing systems, or the like docked with the SNET group, and may be managed by one or more devices, processing systems, or the like docked with the SNET group. For example, a processing system supporting the SNET group may receive and store access rules developed by various SNET group members and utilize such access rules to manage requests by various SNET group members to access various content items via the SNET group. An access rule can also command certain content items to not be displayed to certain SNET group members browsing content items available via an SNET group. For example, a processing system supporting an SNET group may utilize an access rule to not display certain content items to certain SNET group members that are browsing various content items that are otherwise available to members of an SNET group, such as via a content storage device, content source, or the like. Such un-displayed content items are effectively “hidden” from the certain SNET group members.

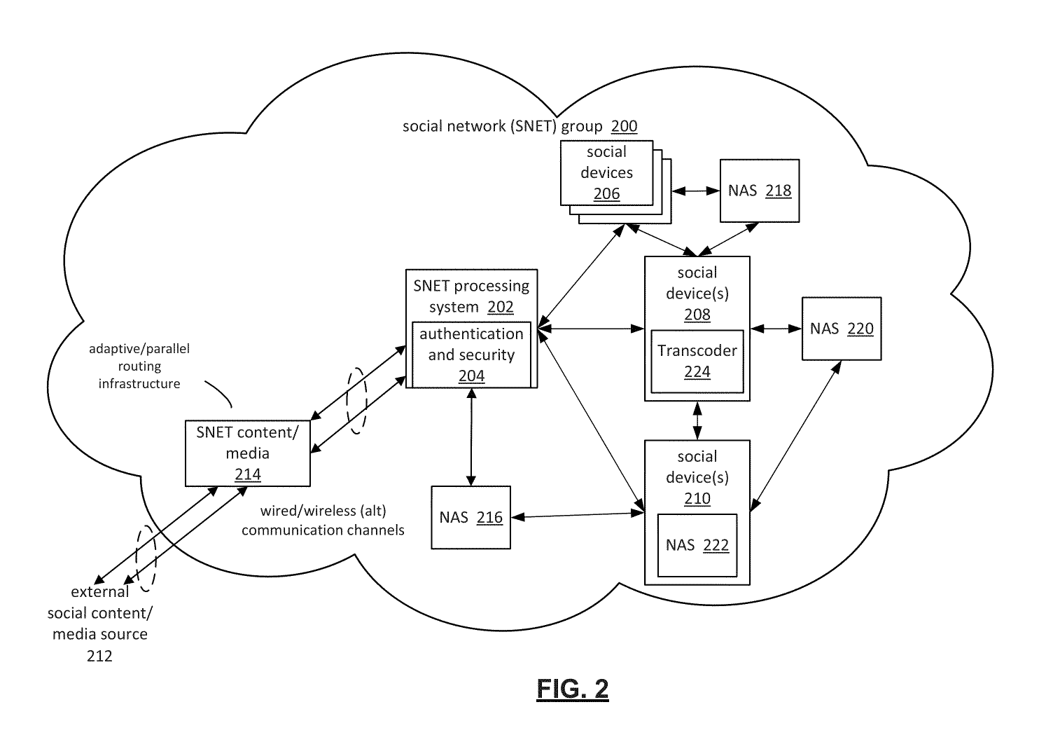

Referring now to FIG. 2, a social network group 200 (hereinafter “SNET group”) suitable for implementing various embodiments discussed herein, is illustrated and discussed. Briefly, membership in the SNET group 200 may comprise docked social devices 206-210, one or more docked NAS storage devices 216, and human SNET group members, as well as proxies thereof. Further, nodes in SNET group 200 may include device services and software (e.g., applications) of various types, which participate as members. Access to specific content and resources of associated with one or more members of SNET group 200 may be shared with one or more other members of SNET group 200, including remote or web-based applications. Such access can be conditioned on acceptable profiling and association data. Similarly, social devices or individuals may be granted temporary or ad hoc memberships, with or without restricted access, and in some cases based on one or more levels of trust.

In the illustrated embodiment, formation, maintenance and operation of SNET group 200 can be performed by one or more standalone or distributed SNET processing systems 202, processing circuitry and software, or the like. It is noted that the “SNET processing system” may comprise one or more instances of hardware, software, applications, or various combinations thereof, and be configurable to support various functionalities disclosed herein. Further, the SNET processing system 202 may be included in a standalone server, server farm, cloud-based resources, and/or the various types of devices described below, and incorporate authentication and security functionality 204, including various embodiments that incorporate device security and trust functionality as illustrated and described in the following figures and accompanying description, and incorporate transcoding functionality. In some embodiments, a SNET processing system may comprise one or more instances of server devices, network nodes, computing devices, and the like. In addition, specialized middleware may also be utilized by SNETs according to the invention, including standardized middleware with an associated certification process. Interactions and interdependencies within the SNET group 200 may involve one or more of a social device association/control module, SNET group member profiling module, and an adaptive resource allocation and arbitration module, as described more fully below.

Distribution of internal and external SNET content/media 214 can be accomplished in a variety of ways in accordance with various embodiments. For example, media distribution may involve an adaptive or parallel network routing infrastructure involving a wide variety of communication protocols and wired and/or wireless communications channels. SNET content/media 214 may comprise, for example, various user-driven (advertising) channels, pictures, videos, links, online text, etc. Access to such content, as well as communications with and remote access to social devices 206-210 of the SNET group 200, may occur over an Internet backbone, cellular communication system, WAN, LAN, etc.

In some embodiments, SNET group 200 facilitates sharing of content and interaction between members of SNET group 200. For example, if one member of SNET group 200 is watching a movie, and another member of SNET group 200 wants to participate along with the other member, SNET processing system 202 can be used to determine a level of allowed participation by consulting user preferences, user and device security and trust levels, content licenses, group policies, and the like. For example, SNET processing system 202 can determine that the second member is permitted to begin viewing the same movie, at the same point in the movie, just as if the second member was watching the movie with the first member in person. SNET processing system 202 may also determine that the second member is permitted to begin viewing the same movie, starting at the beginning, but at a time-shifted rate until the second member has “caught up” with the first member and is watching the same point in the movie as the first member, at which point the second member's view of the movie proceeds at a normal time-rate. Being able to join a movie or other similar content already in progress can provide more personal connections via the social network. The second user might also be able to communicate with the first user via chat or text.

In another example, a user may have set notification alerts within the social network indicating that the user wants to be notified any time another user is playing a video game. SNET processing system 202 can be used to verify billing, access rights, and personal preferences of both users, and based on the verifications, permit the user to join the video game already in progress, and allow the two members to communicate via video/audio, or a combination thereof, so that the two users can play the game together. In some such instances, the SNET itself can hold the license to the video game, and be permitted to distribute a set number of concurrent players without additional cost. Furthermore, the security and trust verifications performed by SNET processing system 202 can be used to ensure that DRM protected content remains protected.

In some embodiments, various instances of content items are stored in one or more various locations associated with SNET group 200. For example, where a user associated with SNET group 200 interacts with social device 208 to purchase a license to access a content item 214 from a third-party social media source 212, an instance of the content item may be stored on one or more NAS storage devices 216 linked with SNET processing system 202, one or more NAS storage devices 220 linked with the social device 208 utilized to purchase the license, one or more NAS storage devices 218 linked with multiple social devices 206 and 208 docked with SNET group 200, one or more NAS storage modules 222 that are included as part of various social devices 210, separate from social device 208, that are docked with SNET group 208, some combination thereof, or the like. A destination NAS storage device can be determined by a user interacting with a docked device, some part of one or more docked devices, a processing system supporting, in part or in full, SNET group 200, some combination thereof, or the like. Storage of the content item 214 may include storing multiple instances of the content item 214 across multiple NAS storage devices, modules, or the like, where permitted. Such storage can be utilized by members of SNET group 200 to access instances of the content item locally to SNET group 200, rather than access an instance of the content item from the content source 212. Such access may be permitted at a rate discounted from a rate for direct access from content source 212, free of charge where permitted by various factors including, without limitation, membership in SNET group 200, geographic location, device capabilities, communication pathway characteristics, some combination thereof, or the like.

In some embodiments, one or more instances of a content item accessed by various members of SNET group 200 are adaptively transcoded to accommodate various communication pathway and device characteristics and capabilities. For example, where one or more devices 208 docked with SNET group 200 include transcoding functionality 224, the transcoding functionality 224 can be utilized to transcode various instances of a content item to be distributed to various members of SNET group 200. The transcoding functionality 224 may be accessed and controlled by SNET processing system 202, one or more social devices docked to SNET group 200, or the like as needed. As a further example, where one or more members interacts with SNET group 200, via one or more social devices 210, to send instances of content item 214, currently stored on NAS storage device 216, to one or more destination social devices 206 for viewing, SNET processing system 202 may determine, based upon data associated with capabilities and characteristics of social devices 206, as well as data associated with characteristics of various communication pathways between NAS storage device 216 and social devices 206, that one or more instances of content item 214 should be transcoded to accommodate one or more social devices 206. The SNET processing system may route one or more instances of the content item from NAS storage device 216 to social device 208, command the social device 208 to transcode the various instances as needed and route the transcoded instances to the various destination social devices 206, route one or more instances of the content item from NAS storage device 216 to social devices 206 via transcoding functionality associated with social device 208, some combination thereof, or the like. As an example, where a movie stored at NAS storage device 216 is to be streamed simultaneously to social devices 206-210, and some selected social devices 206 cannot support the full resolution of the video, social device 208 can selectively transcode instances of the video to be sent to the selected social devices 206 to a lower resolution that is supported by the selected social devices 206. Chained transcoding of instances of a content item can be performed, based upon various capabilities associated with various devices and communication pathways utilized to send instances between devices. For example, where a content item is routed between various docked devices, and communication pathways between the devices have different bandwidth limit, instances of the content item can be transcoded to accommodate the various bandwidth limits of the various communication pathways as the content item is routed between the various devices. Capability and characteristic data utilized to determine optimal transcoding of content items can be distributed between various devices docked to SNET group 200 and updated over time.

Access to transcoding functionality associated with various docked devices, as well as other associated functionality, may proceed independently of interactions between the docked devices and users supported by the devices. For example, SNET processing system 202 may route instances of a content item to be transcoded by functionality 224 of social device 208 when activity associated with the device 208 is low, when a supported user is not interacting with social device 208, or the like. If a user begins to interact with the device 208 during a transcoding process, SNET processing system 202 may adaptively reevaluate the routing of instances of a content item to be transcoded by the device 208; where the SNET processing system 202 identifies a more optimum routing path and transcoding functionality to utilize, at least in part, the SNET processing system can adaptively alter the routing of instances of the content item. For example, when no member is utilizing social device 208, SNET processing system 202 may interact with some part of social device 208 to route one or more instances of a content item to be transcoded by social device 208 and delivered to another destination social device 206; if a member begins utilizing social device 208 during the transcoding process, SNET processing system may determine whether the one or more instances of the content item can be routed to utilize transcoding functionality associated with some other docked device.

In some embodiments, transcoding is based upon optimizing capabilities of various docked devices. For example, where a social device 208 accesses a 1080 p resolution video from NAS storage device 216, and display of the video at the full 1080 p resolution would

In some embodiments, one or more various members of SNET group 200 can access one or more various functional elements, services, applications, and the like associated with various devices, processing systems, and the like associated with SNET group 200. For example, a member may interact with social device 208 to access an application included in SNET processing system 202, such as access to a content item database associated with SNET group 200. In another example, where a social device 206 docked with SNET group 200 includes a set top box (STB) that includes four tuners that can be utilized to access various content items, a user may interact with social device 208 to use one of the tuners included in device 206 to access one or more instances of content items. In some embodiments, a member of SNET group 200 can determine what content items are being accessed, at a given time, by other various members of SNET group 200, and access at least some of the content items being accessed by other SNET group members. For example, a first member of SNET group 200 may interact with SNET group 200, via social device 208, to determine what content items are being accessed by other members of SNET group 200 via social devices 206 and 210. Indications of what content items are being accessed by various members of SNET group 200 can be provided to other members of SNET group 200 via an interface including, without limitation, a real-time updated media feed, a Twitter feed, or the like. Various members can interact with the interface to access the content items being accessed by other members of the SNET group. For example, a real-time updated media feed that indicates content items being accessed by members of an SNET group 200 in real-time may include one or more hyperlinks that a user can interact with to access the content. A user may be able to interact with the feed to join the other one or more SNET group members in a synchronized joint accessing of the content item (e.g., join in a viewing of a film at the point that another SNET group member is at in the film), access the content in a modified manner to enable future synchronized joint accessing of the content item (e.g. view a film from the beginning at time-offset rate, such as an accelerated rate, a decelerated rate, or the like, until the viewing is synchronized with another one or more SNET group members).

In some embodiments, a member of an SNET group can have membership capabilities regarding access to content items from external content/media sources that provide incentives to encourage access to the content items by other members of the SNET group. For example, a member of SNET group 200 accessing a content/media item 214 from an external content/media source 212 may receive various rewards, including, without limitation, additional discounted rates for accessing additional content/media 214, refunds of a fee for accessing the currently accessed content/media item 214, some combination thereof, or the like, for each member of SNET group 200 that is encouraged to join the first member in accessing content/media item 214. The SNET member may be able to encourage access of the content/media item 214 by indicating, via a real-time feed provided to members of SNET group 200, that the first member is accessing the content/media item 214, has accessed the content/media item at some point in time, or the like.

Various members of SNET group 200 may be able to manage feeds presented to them to prioritize indicating certain types of content being accessed by selected members of SNET group 200. For example, where a first SNET group member's choices in Western films are valued highly by a second SNET group member, the second SNET group member may interact with SNET group 200, a processing system 202 supporting the SNET group 200, or the like, to provide the second member with a real-time and historical feed that prioritizes indications of Western films viewed, purchased, bought, or the like by the first member. The feed can be managed to prioritize indications of any accessing of content items by a selected SNET group member, only accessing of selected content items by various SNET group members, some combination thereof, or the like.

In some embodiments, access to one or more functional elements associated with various devices includes control over some or all of the devices. For example, a user may interact with some part of SNET group 200, via social device 210, to control some part of a docked social device 206, a socially controllable device docked, directly or indirectly, to SNET group 200, some combination thereof, or the like. Control of a device can include, without limitation, turning the device on or off, controlling content provided by the device via various interfaces, “slinging” various instances of content from one device to another, some combination thereof, or the like. Such control can be managed by interaction with some part of SNET group 200, to which the various devices are docked, directly or indirectly via one or more devices docked directly to SNET group 200. One or more of SNET processing system 202, a device docked to SNET group 200, or the like can serve as a bridge of signals transmitted between two devices, which can include, without limitation, transcoding control signals, CEC signals, or the like sent from one device to be readable by a destination device.

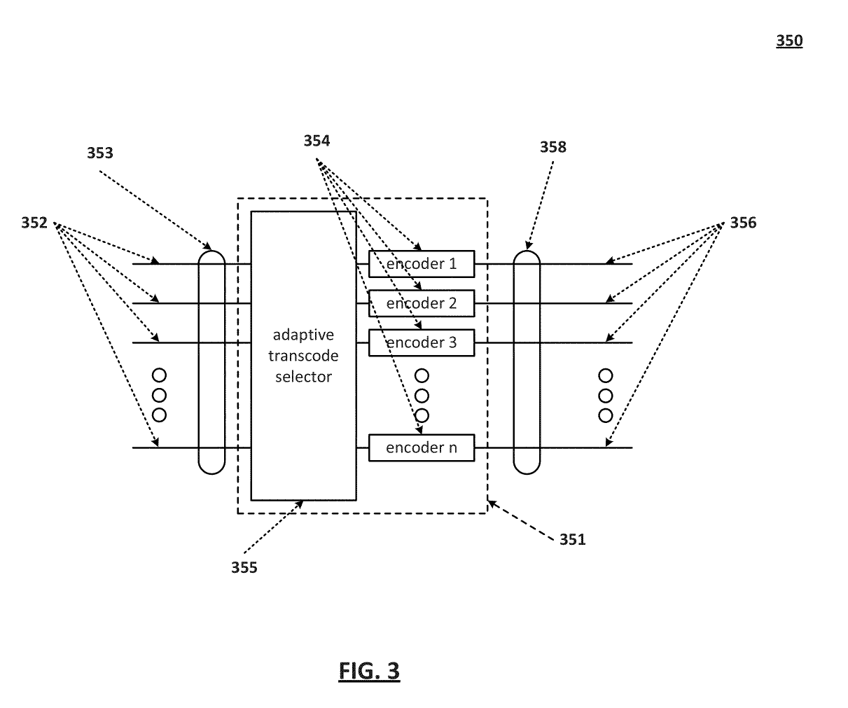

Referring to the embodiment 350 of FIG. 3, this diagram depicts an embodiment 350 that is operable to effectuate selectivity by which different received 353 respective signals 352 may be encoded/transcoded 358 for generating different respective encoded/transcoded signals 356 that may be independently transmitted to one or more output devices for consumption by one or more users.

As can be seen with respect to this embodiment, device 351 includes an adaptive transcode selector 355 that is operative to provide respective 352 to one or more encoders 354. In accordance with one implementation of the architecture of this particular diagram, each respective encoder 354 in the device 351 may correspond to a respective coding. The adaptive transcode selector 355 is the circuitry, module, etc. that is operative to perform the selective providing of the respective signals 352 to one or more encoders 354.

In SNET groups according to various embodiments of the invention, associated social devices and user equipment may have bandwidth, power and cost limitations. At times, via a single social device or grouping of devices, a member may desire additional bandwidth or a reallocation of communication resources for various purposes including, for example, minimizing battery consumption or costs, or co-participation in a download.

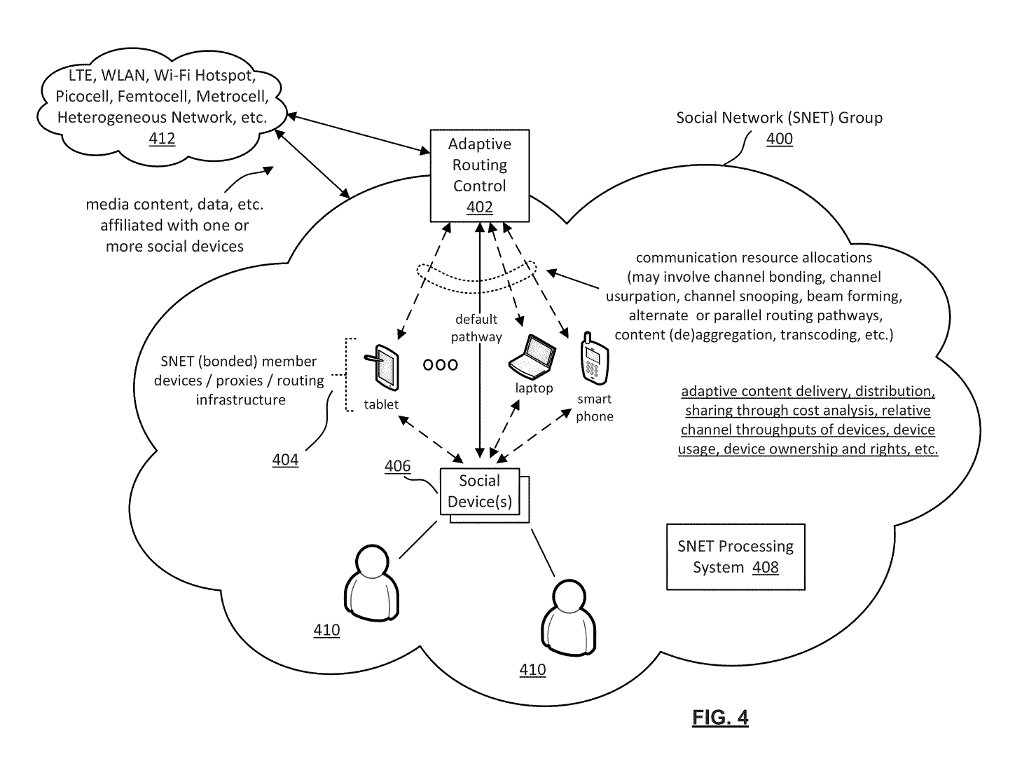

Referring more particularly to FIG. 4, adaptive communication resource allocation and aggregation in accordance with various embodiments of the present invention is shown. In this embodiment, communication resources of social devices 404 and 406 participating in a SNET group/sub-group 400 may be pre-configured (within the SNET group/sub-group 400) to enable alternate or additional communication pathway flows and/or channel bonding and like techniques to enhance or enable communications with internal and/or external sources. Such social groups may be established and maintained by various means, including: ad hoc associations; dockings; cloud and SNET sign-up procedures and/or web-site management; proximity-based associations (e.g., using GPS or in-range detection via wireless LAN or near field communications); etc.

Communication resources of the various nodes of the SNET group/sub-group 400 may include, by way of example and without limitation, integrated and/or combination radio technologies that enable standards-compliant wireless connections of varying bandwidth, capacity and throughput. Data communications within the SNET group/sub-group 400 may include, without limitation, video content items (including video on demand) from an Internet- or cloud-based source or hosted service provider, as well as content from another SNET group/sub-group.

In the illustrated embodiment, embedded or discrete adaptive routing control functionality 402 operates to establish and maintain external and/or internal wired and/or wireless communication pathways between social devices 404 and 406 participating in the SNET group/sub-group 400. As described elsewhere herein, SNET processing system 408 (which might encompass adaptive routing control functionality 402) may be employed to support and supervise at least some part of the SNET group/sub-group 400.

Considerations for establishing and maintaining SNET device relationships may include cost, battery status, current or historical usage, device ownership, etc. Device associations/bonding and capacity allocations may be established for all future communication flows or only for a particular purpose. In addition, security and sub-addressing schemes may allow for device association on a per application basis, single source or proxied delivery, etc.

Social device resource aggregation in accordance with the illustrated embodiment may involve various techniques, such as channel bonding, usurping a channel(s), channel snooping, beam forming, and the like. An adaptive/parallel SNET routing infrastructure is employed in one embodiment, wherein routing strategies that leverage communication link state information may be used to optimize communications within a SNET group/subgroup 400. Further, various acknowledgement (ACK) services may be utilized by devices that employ snooping techniques to facilitate communications (e.g., WLAN communications) with user equipment addressees/proxies. As will be appreciated, certain distributed embodiments may utilize various combinations of such communication topologies and protocols.

Various cost sharing techniques are enabled by social device resource aggregation/reallocation in accordance certain embodiments of the invention. For example, paid content such as video-on-demand may be delivered from an LTE eNodeB (eNB) to a first user 410 via a social device 406, with the content shared by one or more additional user devices in the SNET. In this instance, a sharing device(s) may split or assume the cost of the content. Alternatively, bonded devices may each pay a download price via LTE infrastructure, or use auto price crediting based on WLAN traffic exchange imbalance, etc. Considerations in forming device groups of this nature might include battery information, cost, bandwidth limitations, and other information that is exchanged in advance and dynamically adjusted thereafter as necessary.

In one contemplated embodiment, users 410 of a tablet device and smart phone within a vehicle (e.g., members of a vehicular SNET group/sub-group 400) or relatively confined area may desire to consume the same video. The devices may (i) form a bonding group involving WLAN forwarding of video content or snooping exchanges; or (ii) perform non-bonded downloading through one device/channel, while the other device receives the video content through WLAN forwarding or snooping. Such bonding groups and other ad hoc associations of devices may take the form of an ad hoc SNET group that is terminated upon reaching a destination. Alternatively, remaining or new passengers may continue the SNET group with a revised grouping of members. Further, the SNET group 400 or individuals nodes thereof may access content through opportunistic associations with other SNET groups/sub-groups or proxies. It is noted that the concepts described above may be extended beyond strictly social devices/user equipment to other nodes, e.g., any one or more nodes with at least one participating user equipment device, or even other SNET groups/sub-groups.

Communications between nodes of a SNET group/sub-group 400 may occur via a server/client or peer-to-peer infrastructure. A peer-to-peer implementation allows for ad hoc connections to be established without an access point or gateway, and might be used, for example, when streaming video or sharing/backing up files between social devices in a SNET group wherein access to the Internet is unavailable or undesired. Other applications for SNET group/sub-group communications according to various embodiments of the invention might include collaborative content generation and sharing, affinity group interactions, etc. Content distributed to/from and within an SNET group/sub-group 400 may be subject to various digital rights management (DRM) and content protect operations such that certain data is only available to authorized users/devices of a SNET group/sub-group 400.

In addition, a social device 404 in certain embodiments may be operable as a bridge or proxy node that communicatively couples two or more social devices 404/406 (utilizing, for example, a multicast-type discovery and access protocol). In such embodiments, a bridge or proxy node may communicate or relay queries and advertisements regarding configuration/capability information, and may further operate to process, transcode or modify both data and transmissions relating to configuration/capability information of devices.

Social devices 404/406 may utilize operating systems that support standardized and open source application programming interfaces (APIs) and widgets that function across various cellular networks and service providers. Such APIs may address physical layer control, scheduling of packets, network monitoring, etc. LTE-Advanced, for example, standardizes several technologies related to heterogeneous networks and self-organization, and communications with such networks may involve small cell/standardized APIs that enable interoperability between hardware and protocol software.

In the embodiment of FIG. 4, adaptive routing control functionality 402 or the like may access and relay data from a variety of sources via one or a combination of service providers (e.g., incumbent local exchange carriers and mobile wireless communication companies) and external networks 412. External networks 412 may comprise, for example, one or more of Wi-Fi access points/hotspots, metro-/micro-cells, picocells, femtocells (which typically utilize both cellular and WLAN technologies, and connect to a service provider's network via a broadband connection and backhaul transport network), multi-access networks of small cells, traditional mobile infrastructure, etc. External networks 412 may further comprise wireless Heterogeneous Networks (“HetNets”), which improve communication capacity and coverage through a mixture of such small/large cells, air interfaces, access technologies and spectrum bands, and effectively allow local area networks (e.g., a Wi-Fi network or hotspot) to become an extension of one or more mobile networks.

Communication resource aggregation in accordance with various embodiments of the invention may utilize various existing and emerging approaches to external network discovery and attachment to provide seamless movement (including authentication) between networks and automated selection of the best communication link(s) based on assorted metrics and criteria such as network congestion levels, comparative service subscription levels, data consumption costs, location, SNET member profile information and device capabilities, etc. Such emerging and standardized technologies might include, for example, Hotspot 2.0/Passpoint, a set of standards and certification program by the Wi-Fi Alliance that enables seamless, cellular-like Wi-Fi authentication and roaming (utilizing IEEE 802.11u, WPA2-Enterprise, and EAP-based authentication), as well as the Next Generation Hotspot (NGH) initiative of the Wireless Broadband Alliance (which itself utilizes Hotspot 2.0 as well as other standardized technologies for network discovery, selection and attachment). Such technologies allow for different authentication approaches, including direct authentication with a network operator (e.g., through mobile credentials stored in a SIM card of a social device 404) and authentication through third-party hubs or proxies to a network operator's servers. The adaptive routing control functionality 402 may incorporate and/or support various such technologies and capabilities.

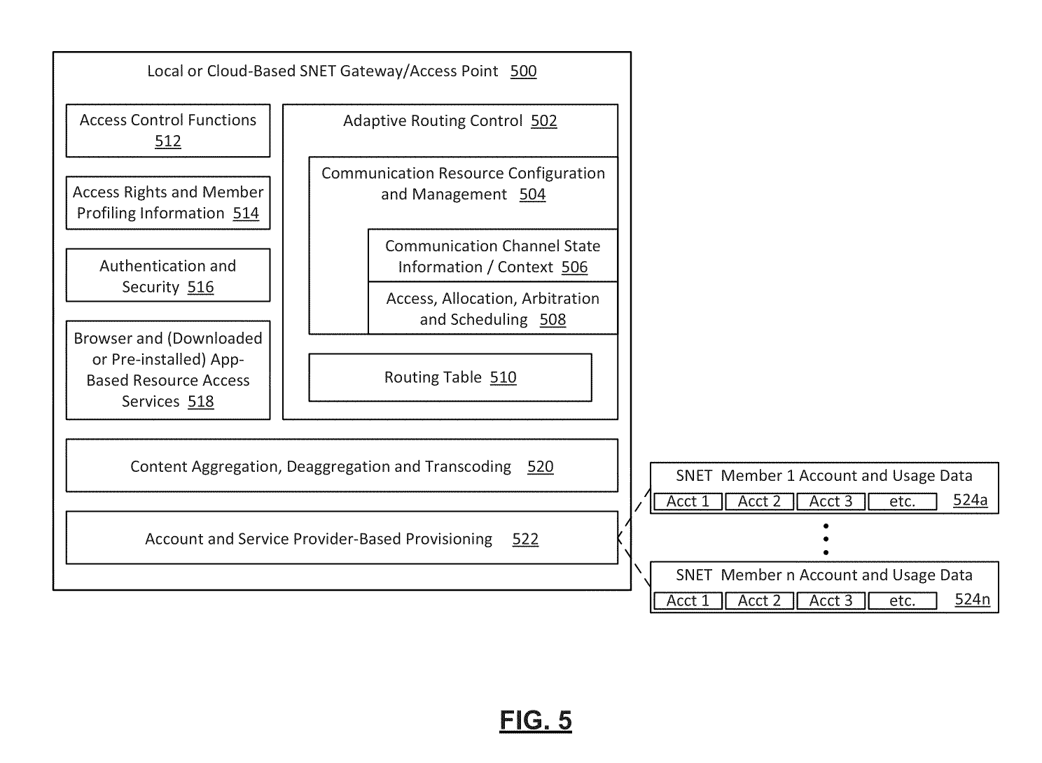

FIG. 5 is a functional block diagram of a local or cloud-based SNET gateway/access point 500 in accordance with one embodiment of the invention. The adaptive routing control 502 of this embodiment includes communication resource configuration and management functionality 504 that utilizes one or more routing algorithms to analyze various metrics associated with given communication pathways or links to determine whether one pathway or link should perform better than another. Relevant cost metrics may include, for example, link utilization, hop count, bandwidth and speed of a path, packet loss/congestion, latency, throughput, load, and other information shown generally as communication channel state information/context 506. Context information may be used, for example, to restore communication pathways that are temporarily aggregated/allocated to support SNET group data communications. Preferred SNET communication pathways may be established and maintained in this embodiment through communication resource access, allocation, arbitration and scheduling functions 508. A routing table 510 can be employed to store information relating to such preferred communication pathways.

The illustrated SNET gateway/access point 500 further includes access control functions 512 operable, for example, to enable full or restricted access to certain communication pathways based on member profiling information and access rights 514. Similarly, authentication and security functions 516 and browser-based or (downloaded or per-installed) application-based resource access services 518 enable automated or user-directed selection of communication pathways (within or external to an SNET group/sub-group).

Content aggregation, deaggregation and transcoding operations 520 function to condition content for transmission over selected communication pathways. Such operations may occur prior to, during or after delivery of content to an SNET group/sub-group. Other operations performed or directed by the SNET gateway/access point 500 might include, for example, account and service provider-based provisioning 522 that enables end users or (bonded) social devices to apportion content costs in an effective and fair manner based on usage data, subscription (e.g., “family plan”) limits, etc. In this embodiment, account and service provider-based provisioning 522 may utilize compiled or available SNET member account and usage data 524a-n.

As will be appreciated, various of the illustrated functional blocks of the SNET gateway/access point 500—such as the those of adaptive routing control 502—may be performed, in whole or part, by other processing systems, devices, or nodes (including bridging and proxy nodes) of a SNET group, service provider network, etc., or through opportunistic associations with other SNET groups/sub-groups. Further, a social device 404/406 in accordance certain embodiments may include functionality accessible by service providers, including auto-configuration, security, authentication and conditional access functions. Such function blocks may be implemented, for example, in a programmable and secure semiconductor device.

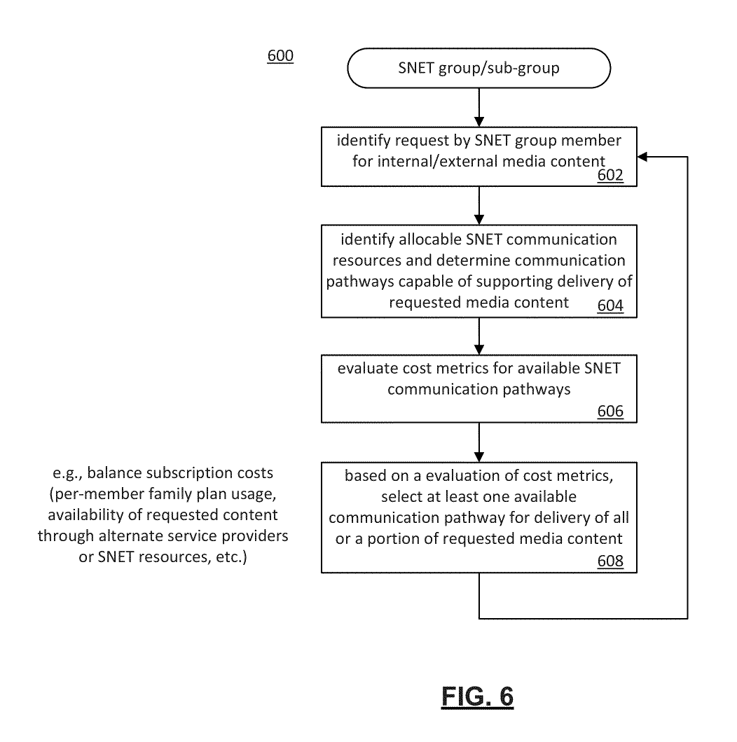

FIG. 6 is a logic diagram of a method 600 for allocating communication resources of SNET group in accordance with an embodiment of the present invention. In step 602 of this embodiment, routing control functions of an SNET group/sub-group identify a request by an SNET group member or node for internal/external media content. Next, in step 604, allocable SNET communication resources are identified and used to determine communication pathways capable of supporting delivery of the requested media content.

Cost metrics associated with such communication pathways are then evaluated in step 606. For example, each link in a given communication pathway may be assigned a context-dependent cost, with the total cost of the communication path being the sum of costs for each link. Based on evaluation of such costs metrics, at least one of the communication pathways is allocated in step 608 for delivery of all or a portion of the requested media content. The method may be repeated to address additional/modified requests for content or changes in the availability or status of network connections and allocated communicated resources (e.g., a participating social device crosses a communication cell and experiences deterioration in coverage or begins to incur roaming charges). In such situations, a portion of the requested content may be downloaded from one service provider, and the remainder from a second service provider, SNET data library, or the like.

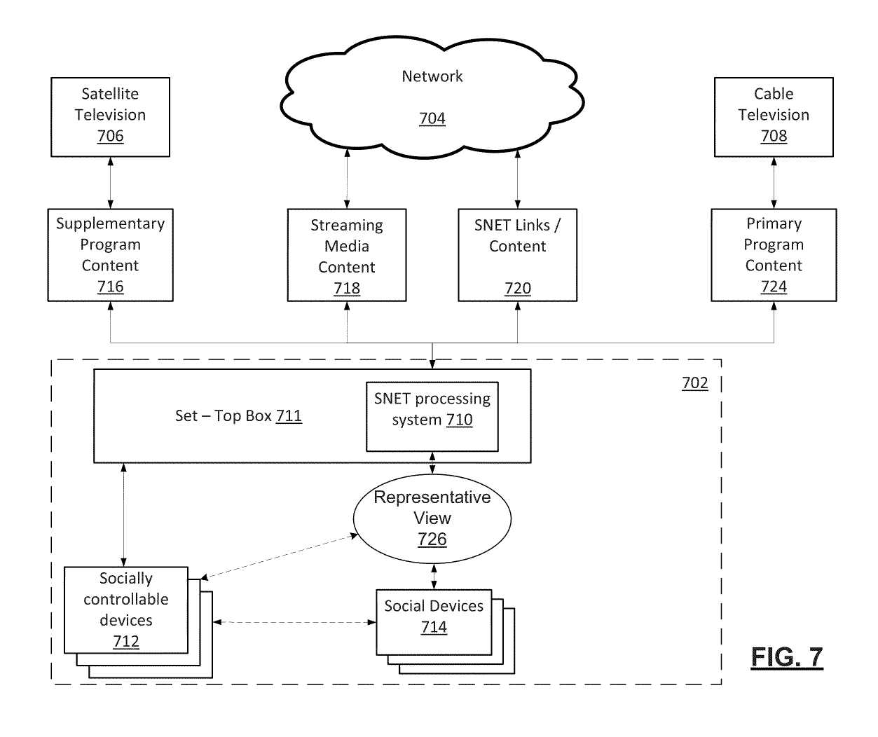

Referring now to FIG. 7, access to various content items via one or more devices associated with an SNET infrastructure 702 are illustrated according to various embodiments. The SNET infrastructure 702 can include one or more processing systems 710 supporting the infrastructure 702, one or more social devices 714 supporting interactions between a member of an SNET with the SNET infrastructure 702, one or more devices 712 that can be socially controlled, including, without limitation, a television device, a media playback device, and the like. In some embodiments, various content items originating from various content sources can be accessed by an SNET member via interaction with a representative view. For example, as shown in the illustrated embodiment, various types of content items including, without limitation, primary program content items 724 from a cable television content source 708, supplementary program content items 716 from a satellite television content source 706, and streaming media content items 718 and SNET links and associated content items 720 from a network 704 may be provided to members associated with an SNET infrastructure 702. Access to the content items 716-324 provided by various content sources 704-308 by a member associated with SNET infrastructure 702, in some embodiments, is facilitated via interaction with a representative view 726 of one or more content items provided by the content sources, the content sources themselves, some combination thereof, or the like. The representative view can be accessed by a member associated with SNET infrastructure 702 by interacting, via an associated social device 714, with an SNET processing system 710 supporting at least some part of the SNET infrastructure 702. The SNET processing system 710 can, in some embodiments, be located in one or more instances of processing circuitry, server devices, set-top boxes, NAS storage devices, computing devices, social devices, some combination thereof, or the like. For example, in the illustrate embodiment, SNET processing system 710 is located in a set-top box (STB) 711 that is associated, docked, or the like with SNET infrastructure 702, which can include an SNET group. Various content items, streams, and the like 716-324 can be provided to the SNET processing system, via one or more links between the STB 711 and the content sources 704-308. The SNET processing system 710 can provide to other social devices 714 associated with SNET infrastructure 702 a representative view 726 of one or more content items provided by the content sources, the content sources themselves, some combination thereof, or the like. For example, representative view 726 may include various interfaces including, without limitation, display icons, that enable a member interacting with the representative view to access one or more content items 716-324 from one or more content sources 704-308. A member may be able to interact with representative view 726, via a social device 714, to access a content item from a socially controllable device 712, such as a television device. For example, a member of SNET infrastructure 702 watching a primary program content item 724 provided to Television device 712 via STB 711 may use a social device 714 to interact with representative view 726 to display a supplementary program content item 716 associated with the primary program content item 724 on Television device 712. In another example, the member viewing a primary program content item 724 on a socially controllable television device 712 may receive audiovisual indications, via the television device 712, of associated supplementary content items 716, streaming media content items 718, SNET links and associated content items 720, some combination thereof, or the like, which the member can access via interaction with representative view via a separate social device 714, interaction with a display provided to television device 712 by STB 711, interaction with a representative view 726 provided to the member via the television device 712, some combination thereof, or the like.

Transitions between content items provided via various content sources can be seamless in a single device. In some embodiments, content items provided from various different content sources are provided via various devices as a content stream optimized for accessing via the various devices. For example, a user viewing primary program content 724 via a Television device can interact with the SNET processing system 710 to switch to a supplementary program content 716 that is related to the primary program content. Such a transition can be in response to a prompt delivered by the SNET processing system 710 to be displayed on a part of the television screen; the user may select to switch immediately to a different content item, such as the supplementary program content, send a command to display the supplementary program content item 716 upon completion of the primary program content item 724, or the like.

In some embodiments, various content items provided via interaction with an SNET infrastructure are accessed as one or more broadcast channels. Such broadcast channels can include content items currently being accessed by various members associated with the SNET infrastructure, content items that have been accessed within a certain period of time, supplementary data related to various content items, feeds related to access of content items by various members associated with the SNET infrastructure, or the like. For example, streaming media content items 718 currently being accessed by a member associated with SNET infrastructure 702 may be presented to various socially controllable devices 712 associated with SNET infrastructure 702 via STB 711 as a broadcast channel dedicated to content items currently accessed by members associated with SNET infrastructure 702. The broadcast channel can be created by some part of SNET processing system 710, STB 711, or the like. As another example, a real-time text feed that provides indications of activities of various members associated with SNET infrastructure 702 can be provided to socially controllable devices 712 as a broadcast channel. Where a socially controllable device is a television device, a user interacting with the device may view channels dedicated to currently-accessed content items, a text feed, supplementary content items associated with primary content items currently being displayed on another broadcast channel, content items from one or more networks, some combination thereof, or the like.

In some embodiments, content items to be included in a created broadcast channel can be restricted to selected content items based upon various factors. For example, selected content items may be restricted to content items explicitly marked for inclusion in a created broadcast channel by a selected number of members associated with an SNET infrastructure, content items receiving a minimum rating by members associated with an SNET infrastructure, some combination thereof, or the like. Created broadcast channels can be integrated with preexisting broadcast channels by some part of STB 711 and sent to devices associated with SNET infrastructure 702, via representative view 726, via interaction with STB 711, or the like. A channel guide listing content items scheduled for presentation on a created broadcast channel can be created and presented to members associated with SNET infrastructure as a separate broadcast channel, presented to members via representative view 726, some combination thereof, or the like. Both a created broadcast channel and a channel guide can be altered on the fly, in response to various tracking data, inputs from various members associated with the SNET infrastructure, inputs from various content sources, some combination thereof, or the like.

In some embodiments, interactions between members of an SNET infrastructure 702 and one or more content sources is bidirectional. As a result, a content source can receive real-time or near real-time feedback from various members accessing a content item. For example, where a member of SNET infrastructure 702 is accessing a primary program content item 724 via interaction with a socially controllable device 712 and is developing commentary related to the content item 724 via interaction with a representative view 726 on social device 714, the commentary may be made accessible to a content source, content provider, or the like associated with the primary program content item 724. The source can include the same source 706 of the primary program content item 724, a separate source located on a network 704 that is associated with the content source, some combination thereof, or the like. The commentary can be provided to a source via transmission by some part of STB 711. In another, the commentary is stored on some part of SNET infrastructure 702, and some part of network 704 is authorized to access the commentary from some part of SNET infrastructure 702. The supplementary data can be extended to other members, devices, and the like associated with SNET infrastructure 702 concurrently with creation of the supplementary data. For example, the supplementary data can be provided to other members as a text feed displayed in a representative view 726 as a text posting that is updated in real-time as additional supplementary data is developed. The feed can be provided to various content sources, the various content sources can be granted access to the feed, or the like. For example, SNET processing system 710 may authorize a content provider provided located on network 704 to access supplementary data associated with certain primary program content items 724, where the content provider is determined to be associated with the content item, authorized by another third-party entity to access the supplementary data, or the like. Such an authorized content provider can include an entity association with creation or marketing of the primary program content item 724, an advertiser associated with the primary program content item, 724, or the like.

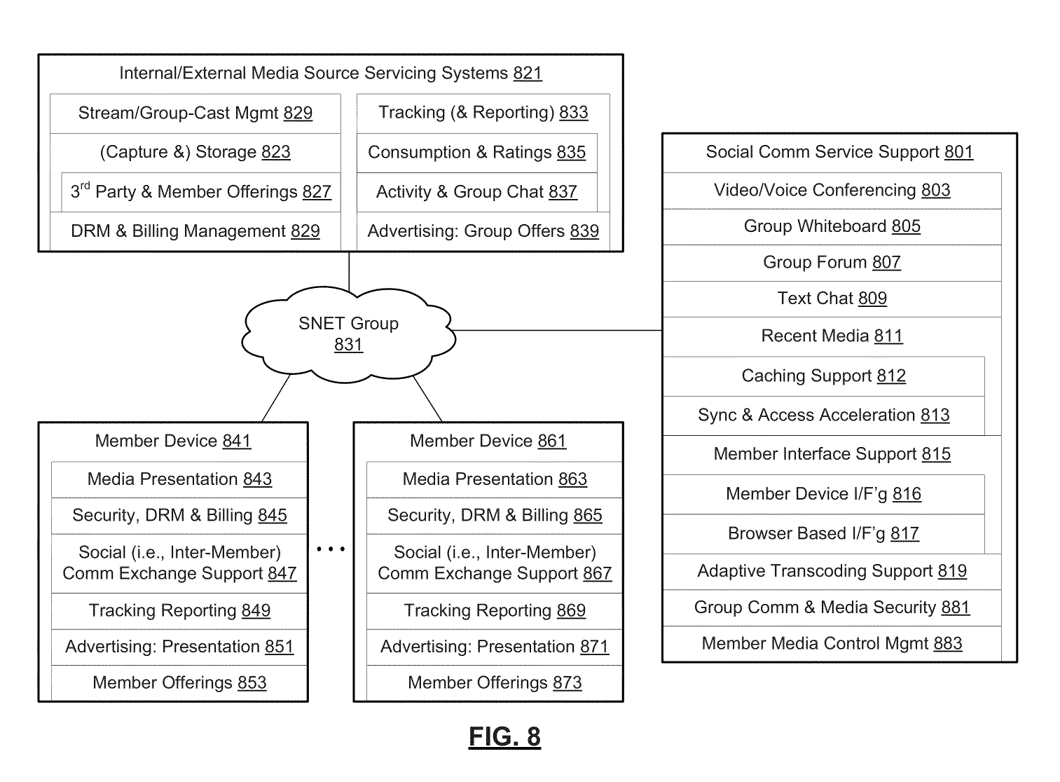

Referring next to FIG. 8, a social networking environment according to various embodiments is illustrated and discussed. An SNET group 831 can be associated with various members devices 841 and 861, and can be supported by various servicing systems 821 and service supports 801. In some embodiments, various servicing systems 821 and service supports can be managed by one or more processing systems, server devices, network nodes, computing devices, or the like. For example, some or all of servicing systems 821 can be managed by a first processing system supporting SNET group 831, and some or all of service support 801 can be managed by a second processing system supporting SNET group 831. Various member devices 841 and 861, with various capabilities, characteristics, and the like, may be docked, associated, or the like with SNET group 831. Docked member devices can, in some embodiments, participate in consumption of content items from sources internal to the SNET group, external to the SNET group, and the like. Content items can include, without limitation, media content, streaming content, advertising content, supplementary data, some combination thereof, or the like. Content sources internal to the SNET group can include content items stored on various content storage devices, NAS storage devices, member devices, cloud storage systems, or the like that are docked, associated, or the like with the SNET group. Content sources external to the SNET group can include, without limitation, member devices not docked to the SNET group, third-party content storage devices, third-party content distributors, some combination thereof, or the like. For example, a Netflix media library or service may be some or all of an external content source. External content sources can be docked, associated, or the like with an SNET group to enable members of the SNET group to access content items from the external content sources by interacting with some part of the SNET group, servicing systems or service support that support the SNET group, some combination thereof, or the like. For example, a user may use docked member device 841 to interact with SNET group 831 to select and access a content item from an external content source that is docked to SNET group 831. An external content source may provide benefits, discounts, access incentives, or the like to members accessing content from the external content source via interaction with a docked SNET group. For example, an external content source docked to SNET group 831 may permit content items accessed from the external content source to be stored in a content storage device docked with the SNET group 831 and permit discounted access to the content item for other members of the SNET group 831 that access the content item from the content storage device rather than accessing the content item directly from the external content source. Such permissions can permit efficient access to content items and reduced traffic between the external content source and various members.

In some embodiments, a member of an SNET group can offer content items for access (“consumption”) by other members of the SNET group. The member may push the offered content items to a storage device docked to the SNET group, a system that supports the SNET group to store the content item or route it to a storage location, some combination thereof, or the like. The member may also keep an instance of the content item stored on a local device supporting the member, and allow other members of the SNET group to interact with the device to access instances of the content item. In such case, the member may permit other members to copy instance of the content item for storage at other locations. For example, as shown in the illustrated embodiment, member devices 841 and 861 include member offering elements 853 that a member can utilize to select content items to be offered to other members of SNET group 831. Member device 841 may specify, through member offerings 853, that a content item stored locally to member device 841, on another device managed by the member, or the like, can be accessed by member device 861 to access selected content items. As another example, a member may utilize member offerings 873 on member device 861 to push a content item stored on member device 861 to SNET group 831, so that other members of SNET group 831 can access the content item without accessing the member device 861. A servicing system 821 supporting SNET group 831 may include a capture and storage module 823 that receives content items pushed by various members to SNET group 831 and routes the content item to be stored in one or more locations. Such storage locations can include, without limitation, a cloud storage system, a storage system local to a processing system, one or more content storage devices, NAS storage devices, or the like docked with SNET group 831, or the like. Module 823 may route pushed content items to other member devices to be stored. Storage (“caching”) of some or all of a content item can be performed by caching support 812 in response to an input from a member device, logic associated with a processing system, some combination thereof, or the like. For example, where servicing system 821 receives a request to purchase access to a content item offered by an external content source, the servicing system may, through caching support, determine one or more storage locations for an instance of the content item, route the instance to storage, and the like. A storage location may be determined based upon several factors including, without limitation, communication pathway characteristics associated with various storage locations, access habits of members supported by the storage locations, available memory of the storage locations, some combination thereof, or the like. Various members of SNET group 831 may be able to access the stored instance, rather than interact with the external content source, and may receive various incentives, rewards, or the like from the external content source for storing and accessing content items in storage locations docked to the SNET group. For example, an SNET group member may receive a discount for accessing a content item from a docked content storage device, rather than access the content item from an external content source. Such rewards and incentives may be indicated to SNET group members as offers 839 from servicing system 821, as a presentation 851 and 871 delivered to one or more member devices 841 and 861, some combination thereof, or the like. In addition, members of an SNET group may receive offers based upon access habits of members of the SNET group. For example, where members of SNET group 831 tend to access western films, an advertising module 839 may present offers to the members of the SNET group 831 from various external content sources, advertising sources, or the like that are related to western films.

Content items that are made available to other various members of SNET group 831 can be displayed to members of the SNET group 831 via an offerings module 827, which can present a representation of an offered content item in a representative view of some or all of the SNET group 831. A member of SNET group 831 can interact with the representative view to select and access an offered content item. In addition, module 827 can present representations of content items available for access by members of SNET group 831 from an external content source, including, without limitation, purchase of access to a media content item from an external media source, media library, or the like.

In some embodiments, multiple members of an SNET group can access content simultaneously (also referred to herein as accessing content in parallel) as part of a group-cast of the content item. For example, members of SNET group 831 can receive a synchronized video stream in on separate devices 841 and 861 via interaction with SNET group 831. A group-cast can be managed by a management module 829 that is part of a servicing system 821. The management module 829 may send a stream to multiple devices based upon input received from one or more SNET group members. In some embodiments, one or more SNET group members can interact with module 829 to control group-casting to various member devices, including, without limitation, selecting various group-cast destination devices, managing display of the group-cast to other SNET group members via an activity module 837, enable various access capabilities including, without limitation, chat services interactions between SNET group members during group-casting, some combination thereof, or the like. Group-casting management can be managed, in part or in full, by a processing system supporting the SNET group.

In some embodiments, control of various devices docked to an SNET group is granted to one or more members of the SNET group. Such control may be granted to facilitate synchronized access of a content item by multiple member devices. For example, where multiple members of an SNET group desire to watch a film offered to members of SNET group 831 via offerings 827, a first member may access one or more of group-cast management 829, member media control management 883, member interface support 815, some combination thereof, or the like to control various member display devices, to ensure that the group-cast experience is synchronized for the various member display devices such that the member display devices each access the film.

In some embodiments, content items accessed by various members of an SNET group can be transcoded to accommodate various characteristics and capabilities of devices, communication pathways, and the like associated with the SNET group. For example, where member device 841 accesses a content item from storage 823, but the resolution of the content item is incompatible with the resolution capabilities of device 841, an adaptive transcoding support 819 can transcode the content item to a resolution compatible with the device's 841 capabilities. In another example, where multiple members of SNET group 831 are participating in a group-cast of a content item from storage 823, but various member devices are linked by communication pathways with various bandwidth limitations, adaptive transcoding support 819 can route an instance of the content item to be transcoded to accommodate a communication pathway along which the instance is to be sent. A transcoder device can be located at a central node, such as a router device, a member device, or the like. The transcoding support 819 can determine the most efficient (e.g., least bandwidth intensive) transmission route for instances of a content item to a destination member device 841, identify transcoders in devices, processing systems, nodes, or the like that are associated with SNET group 831, and send an instance of the content item to a device including the transcoder to be transcoded and forwarded on to the destination device. In some embodiments, various devices, processing systems, nodes, and the like associated with an SNET group can receive capability and characteristic data associated with various other devices and communication pathways associated with the SNET groups. In such case, the various devices may transcode received content item instances to be forwarded to other devices based upon the received capability and characteristic data to accommodate various communication pathways and device capabilities.

In some embodiments, synchronization and access acceleration support 813 enables an SNET member to join other SNET group members in accessing a content item, even when the other members have already accessed some part of the content item. Such joining may include permitting a joining member to being access synchronized with the other members, accessing the content item from the beginning in a time-shifted manner, or the like. For example, an SNET group member wishing to join other members who are part-way through watching a film, may choose to “jump in” to begin watching the film at the same point in the film as the other members, begin watching the film from the beginning in a time-shifted manner until his view of the film is synchronized with the other members and proceeds at a synchronized rate, or the like. Time-shifted access can include, without limitation, viewing a content item at a reduced frame-rate, a faster viewing-rate (e.g., 1.5 times normal viewing rate, 30 frames per second rather than 50 frames per second), or the like.

In some embodiments, synchronization and access acceleration support 813 manages synchronized access to one or more content items by various member devices. Support 813 may solicit data from member devices 841 and 861 that are simultaneously accessing a content item to determine whether their access of the content item is synchronized within a certain margin. Where their access is not synchronized, support 813 can alter an aspect of an instance of the content item provided to one or more member devices to establish synchronized access of the content item. For example, where support 813 receives data indicating that member device's 841 access of a content item out of sync with member device 861's access of the same content item, support 813 may utilize adaptive transcoding support 819 to accommodate member device's 841 capabilities to re-synchronize access. In some embodiments, synchronization and access acceleration support 813 manages synchronized access to a content item by various members via one or more processes. For example, as noted above, support 813 can adaptively transcode various device's access of the same content item. In addition, synchronization and access acceleration support 813 can include active transcoding, buffer management, and the like.

In some embodiments, Support 813 establishes synchronized access by time-shifting member device 841's access of the content item (e.g., reduce the number of frames of a video content item, play the video content item at a slightly faster rate, etc.) to establish synchronized access. The various measures taken by support 813 over time to manage synchronized content access can adapt to changing conditions in SNET group 831. For example, where member device 861 becomes overtaxed by various other functions, such that the member device 861 is unable to maintain access of a content item that is synchronized with access of the content item by member device 841, Support 813 may use adaptive transcoding support 819 to reduce the resolution of the instance sent to member device 861 to maintain synchronized access.

In some embodiments, content items accessed within a certain period of time by SNET group members are monitored and indicated to other members of the SNET group. For example, recent media support 811, one or more tracking modules 833, 849, 869, caching support 812, some combination thereof, or the like, may track what content items are being accessed by SNET group members, have been accessed in the past by SNET group members, and the storage location, if any, of the accessed content items. Content item accesses by various SNET group members can be presented to various other SNET group members via a feed displayed in a representative view associated with SNET group 831. Various members can interact with the feed to view the access habits of other group members, see what content items are currently being accessed, join in ongoing access of content items by various group members. Select and access various content items displayed in the feed to have been accessed by other group members, some combination thereof, or the like. To this end, a feed may include links that a member can interact with to access a content item indicated in the feed. Upon receiving indication that a link has been selected by a member, a servicing system, member device, or the like can interact with caching support 812, synchronization and access acceleration 813, transcoding support 819, some combination thereof, or the like to facilitate access of the selected content item by an SNET group member.

In some embodiments, tracking and reporting 833 of access of content items by members of SNET group 831 includes presenting SNET group members with representations of access of content items, presenting supplementary data associated with the content items, facilitating interactions between SNET group members accessing one or more content items, or the like. For example, a servicing system 821 can provide members browsing a feed of recently accessed content items with a selection of supplementary data, including commentary, reviews, ratings, and the like associated with the content item. The feed can be the supplementary data presented can prioritize any supplementary data developed by the SNET group member indicated in a historical access feed to have accessed the content item most recently. Supplementary content may include commentary associated with access of the content item. For example, where multiple members of SNET group 831 are viewing a group-cast of a film, a real-time feed of content item accessing by members of the SNET group that is presented in a representative view of some or all of the SNET group 831 to other group members may include, in addition to an indication of the ongoing group-cast, running commentary about the content item, information, such as a password, required to join in the group-cast, or the like.

In some embodiments, a feed includes advertisements, advertisement offers related to accesses of content items, and the like. For example, where a first member of SNET group 831 is currently accessing a content item from an external content source, and a feed created based upon tracking 833 of the first member's access presents an indication to viewers of the feed that the first member is currently accessing the content item, the feed can also include an advertisement offer 839 to other members of the SNET group 831 that offers a discounted rate for accessing the same content item, similar content items, or the like. Such offers may be time-limited to the duration of the first member's accessing of the content item, to a predetermined time period, or the like. A member of SNET group 831 may be able to accept the offer by interacting with the offer in a representative view; upon receiving acceptance of the offer, service system 821 may present an accepting member with the offer to jump to a point in the content item that is synchronized with access to the content item by another SNET group member (e.g., jump to the same point in a film as another SNET group member currently watching the film), access the content item in a time-shifted manner to eventually synchronize with another SNET group member's access, access the content item in a normal, unsynchronized, manner, or the like.

In some embodiments, a member interacts with various services, support elements, and content items associated with a SNET group by interacting with a representative view of some or all of the SNET group. Such interaction can proceed via interaction with a user interface on a member device. Presentation of a representative view can be tailored to accommodate various SNET group members, various member devices, various interface capabilities associated with same, and the like. For example, interface support 815 can include support for various member device interfaces 816, including, without limitation, television device interfaces with a representative view, computing device interfaces with a representative view, and the like. Interface support 815 can include support for various browser-based interfaces. A representative view may be tailored to accommodate the capabilities and characteristics of the device, browser, or the like used to interact with a representative view. For example, a member device that is a mobile wireless device, such as a smartphone, may be provided a representative view that is less bandwidth-intensive than a representative view provided to a desktop computer. As another example, a member device that is a television device may be provided a representative view that accommodates user selection via a television remote control device with a limited number of control buttons, while a member device that is a laptop computer may be provided a representative view that accommodates user selection via a mouse cursor and keyboard.

In some embodiments, various members of an SNET group can communicate and interact as part of joint or independent access of various content items. Such communication and interaction can include, without limitation, chatting in a chat feed, interacting in a dedicated SNET group forum, drawing and writing in a group “whiteboard” display, communicating via a video or voice conference, some combination thereof, or the like. A servicing system 821 supporting SNET group 831, for example, can include module 837 that manages group member interactions and communications. A service support 801 can include support for video/voice conferencing 803 by various SNET group members, access to a network-based group forum 807, access to a “whiteboard” system 805 that enables group members to write, draw, or the like on a page presented to all participating members, a text chat system 809 that supports text-based communications between various SNET group members, some combination thereof, and the like. Partial or full support for inter-member communication and interaction can be provided by modules 847 and 867 located on various member devices 841 and 861. As an example of interaction related to access of content items, various members of SNET group 831 viewing a group-cast of a film may be provided, as part of a display on member devices used to watch the film, a representative view that includes a field that displays the film, a field that includes a text-based chat feed that the viewing group members can use to type messages to some or all of the other group members viewing the film, a “whiteboard” that group members can use to draw or write messages, images, or the like for other group members, an interface to access a forum where group members can discuss the film, and the like. Communication interfaces can be tailored to specific activities, and use of the interfaces can be restricted to the group members participating in the activity. For example, in the above example of a group-casting of a film, text chat fields, whiteboards, forums, and the like presented to group members participating in the group-cast may be available only to those group members viewing the film, unless provided for otherwise by one or more group members.

In some embodiments, interactions between various SNET group members, services, processing systems, content sources, and the like may include various security layers 881, 845, and 865 to restrict access to various information associated with the SNET group. Security layers can include, without limitation, digital rights management (DRM) restrictions, DRM licenses, various content protection processes, some combination thereof, or the like. Restricted information can include restricted access to content items, supplementary data, communication and interaction data, access activities and habits, some combination thereof, or the like. Various content items may include DRM restrictions that restrict access to the content item based upon membership in an SNET group. Certain activities can be restricted from being joined, accessed, or even viewed in a feed, by other SNET members. For example, a group-casting of a content item can be hidden such that no indication of the group-casting is presented to other members of the SNET group via an SNET group activities feed, content item access history feed, or the like.

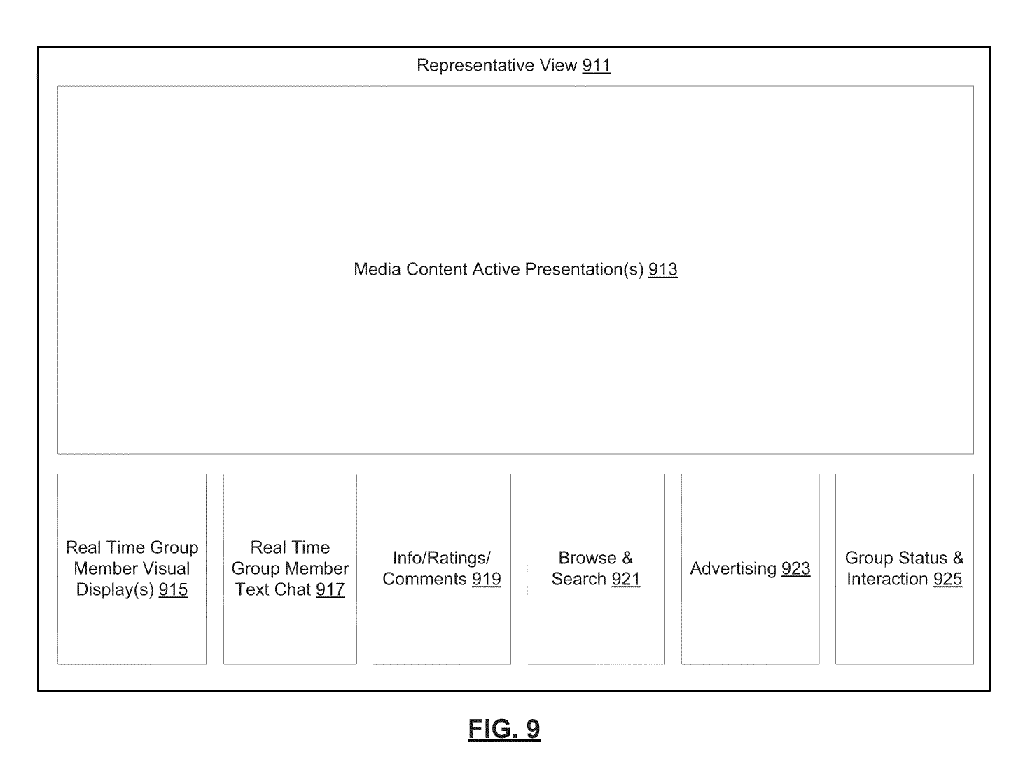

Referring now to FIG. 9, a representative view 911 according to various embodiments is illustrated and discussed. In some embodiments, a representative view 911 can present representations of various content items, services, applications, device capabilities, and the like to a member via a display interface. The representative view can be optimized to be presented via a certain interface device. For example, representative view 911 may be optimized on a per-member basis to accommodate the optimal display resolution of an interface device used by the member to interact with the representative view. Representations presented in the representative view can also be tailored, one a device-by-device basis, to accommodate characteristics and capabilities of the interface devices. For example, a representative view presented to a member via a television device display may include representations that can be easily interacted with by a user via a remote control device, while a representative view presented to a member via a computer display may include representations that can be more easily interacted with by a user via a computer mouse device.

In some embodiments, a representative view includes various fields that present various services, access to various content items, communication and interaction with various SNET members, information, and the like. For example, as shown in the illustrated embodiment, representative view can include a field 913 that presents a content item being accessed by an SNET group member. A representative view can include multiple fields to simultaneously present multiple content items that may or may not be related.

A representative view 911 can include a field 915 that presents a visual display of one or more members of an SNET group associated with representative view 911. The visual display can include a real-time video display of one or more SNET group members, one or more icons representing one or more SNET group members, some combination thereof, or the like.

A representative view 911 can include a text chat field 917 that a member can interact with to chat with one or more SNET group members. The SNET group members that a member can chat with via field 917 can be restricted based upon member preferences, simultaneous access of one or more content items, or the like.

A representative view 911 can include a field 919 that presents supplementary data related to a content item being presented in another field 913 of the representative view 911. For example, where a field 913 presents a film, field 919 may present commentary of some or all of the film, information about tabs that a member may select to skip to certain parts of the film, review and rating information related to some or all of the film, and the like. Supplementary data presented may change based upon the part of a content item being accessed. For example, commentary and reviews of scenes of a film being presented may change as viewing of the film progresses, where the commentary presented in field 919 changes to synchronize with the scenes of the film being presented in field 913.

A representative view 911 can include a field 921 that presents a browsing and searching function that a member can interact with to interact with some part of a network. For example, a member may interact with field 921 to browse all content items that are available to the member as a member of a certain SNET group, available via interaction with various content sources, and the like. Field 921 may include a search field into which a member can type search queries, a browsing window that a member can use to browse content items organized according to storage location, genre, type, or the like.

A representative view 911 can include a field 923 that presents advertising content. Advertising content presented can be related to at least some content items accessed by various members of an SNET group. For example where representative view 911 is currently presenting a western film in field 913, advertising field 923 may present advertisements that include offers related to western films. Such offers may include discounts for accessing content items previously accessed by SNET group members, currently being accessed by SNET group members, content items of similar type, some combination thereof, or the like.

A representative view 911 can include a field 925 that presents information related to various statuses and interactions related to an SNET group associated with the representative view 911. Such information can include a text feed that presents indications of content items accessed by various members of the SNET group, activities by various members of the SNET group, statuses associated with various members of the SNET group, supplementary data developed by various members of the SNET group, some combination thereof, or the like. A feed can include links that a member can interact with to perform certain activities. For example, a content item indicated in the feed can be presented as or with a link that a member can select to access the content item. As another example, an indication of an ongoing group-cast of a content item by various members of the SNET group may include a link that a member can select to join the group-cast.

Various fields included in a representative view can be managed, altered, opened, closed, resized, and the like by a member device, processing system, or the like—based upon preset member preferences, by a member on the fly as the member so desires, or the like.

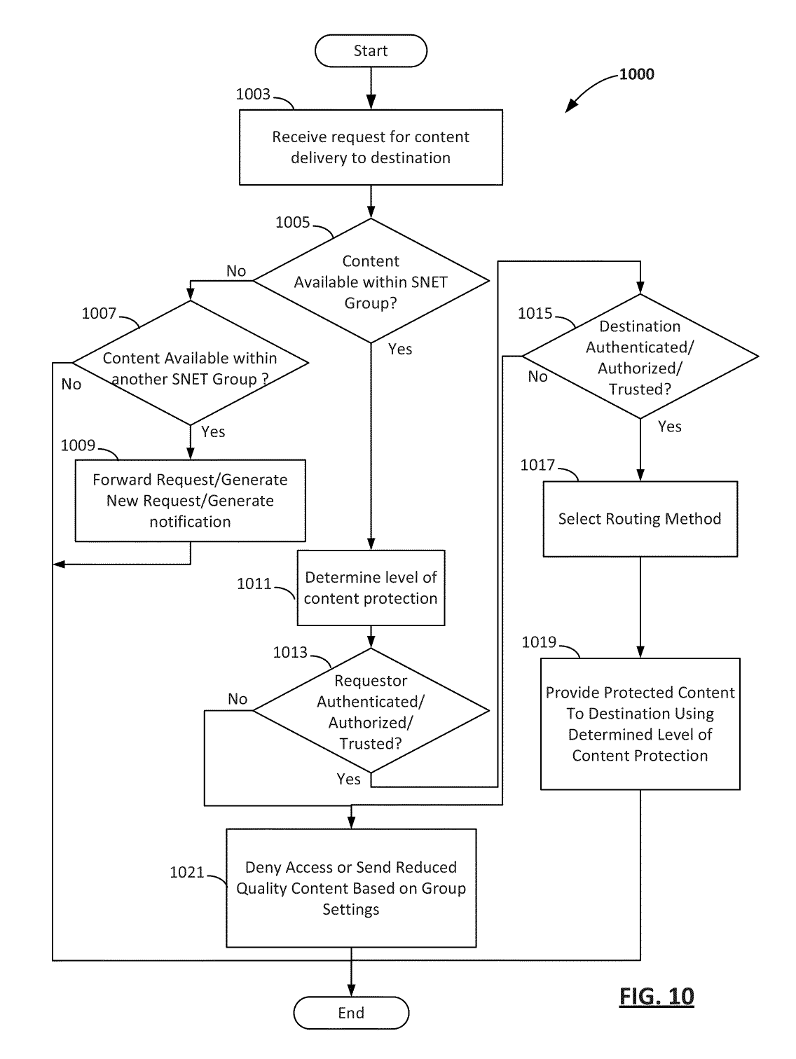

Referring next to FIG. 10, a flowchart illustrating a method 1000 is discussed according to various embodiments. At block 1003, a request is received for content delivery to a destination device. The request can be for delivery to the same device requesting the content, or to a different device. The request can also be for delivery of content either within the SNET group providing the content, within an SNET but outside the group providing the content, or from outside the SNET.

As illustrated at block 1005, a determination is made about whether the requested content is available within the SNET group. Determining whether the requested content is available can include determining both whether the content is available from the device receiving the request, and whether the requested content is available from a different device within the SNET group. As illustrated by block 1007, if content is not available within the SNET group a check is performed to determine if the requested content is available from within another SNET group within the same SNET. If the requested content is not available from the SNET group or from another group within the SNET, method 1000 ends. In some embodiments, although not specifically illustrated by method 1000, a response can be sent to the requestor indicating that content is not available.

If the determination made at block 1005 is favorable, indicating that the requested content is available within the SNET group from which it was requested, a level of content protection is selected, as illustrated at block 1011. The level of content protection can be selected based on DRM restrictions, preferences, and statuses associated with particular content, particular destinations, particular requestors, particular combinations of destinations and requestors, or the like. For example, a first level of content protection may be applied to content delivered in response to a request by a particular requestor for delivery to a social device docked to the SNET group and associated with the requestor, but a second level of content protection can be applied if delivery is requested to a device not associated with the requestor.

As illustrated by block 1013, a status of a requestor is determined by checking to see if the requestor has been authenticated, authorized, and is trusted. In some embodiments, the status of the requestor is determined prior to selecting the level of content protection at block 1011. If the requestor's status is unfavorable, that is to say if the requestor is not authenticated, authorized, and trusted, access to the requested content can be denied, or reduced quality content can be provided, as shown by block 1021.

If the requestor is authenticated, authorized, and trusted, a status level of the destination device can be verified at block 1015. Verification or determination of the destination device's status can include determining whether the requested destination is authenticated, trusted and authorized. In some instances, determining the status of the destination device includes determining a status of multiple devices in the destination path. For example, if content is to be delivered to a destination device through an intermediate device the status of the intermediate device can also be determined. In some embodiments, a device is determined to be authenticated, authorized, and trusted based upon its association with the SNET group. For example, where a DRM restriction associated with the requested content restricts access to the content to devices docked with the SNET group, devices associated with members of the SNET group, and the like, determining a status of the requestor can include determining whether the requestor is a member of the SNET group, determining whether a requesting device is docked to the SNET group, determining whether the destination device is docked to the SNET group, determining whether the destination device is associated with a member of the SNET group, some combination thereof, or the like.

If the status of the destination device determined at block 1015 is unfavorable, access to the requested content can be denied, or reduced quality content can be provided, as shown by block 1021. If, however, the status of the destination device is favorable, a routing method for the requested content can be determined at block 1017. In some embodiments, selecting a routing method includes determining whether the content is to be sent substantially directly to the requesting device by a content storage device, or whether the content is to be sent to an intermediate node with the same SNET group for content protection, tagging, transcoding, or the like to be applied. Selecting the routing method can also include determining whether an SNET host will relay the content outside of the SNET or SNET group, whether the content is to be sent via a VPN or using a firewall, and the like.

As illustrated at block 1019, after the status of both the requestor and the destination device have been determined to be acceptable, the protected content is provided to the destination device using the determined level of content protection and using the selected routing method.

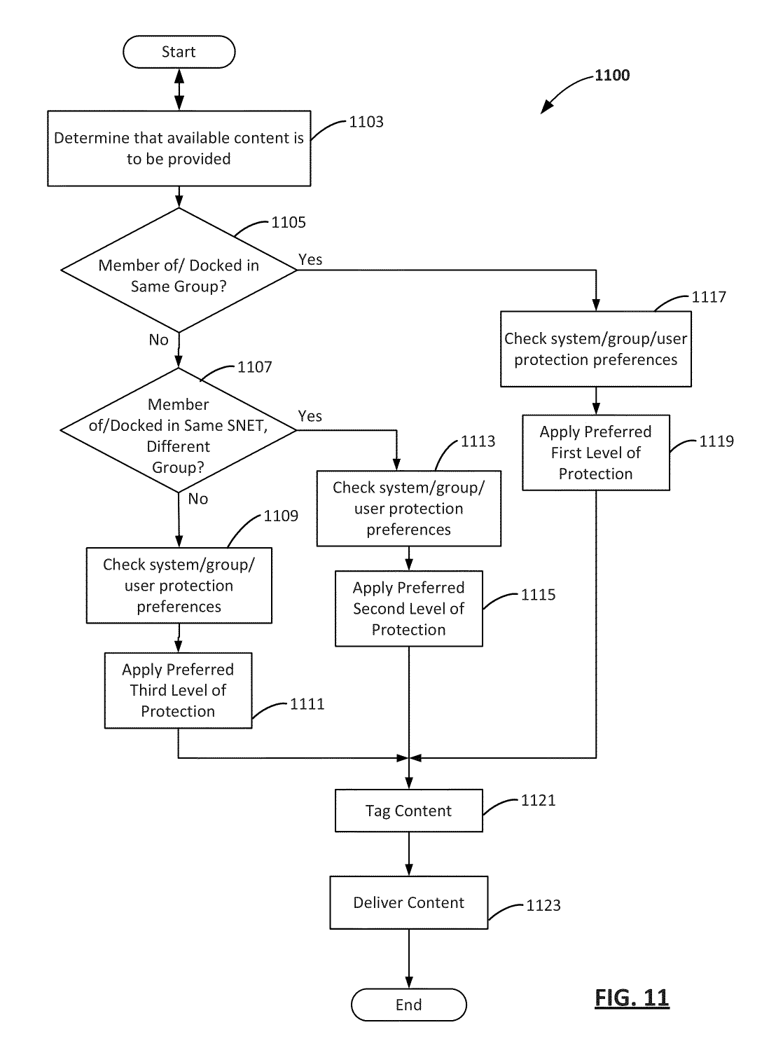

Referring next to FIG. 11, a method of determining the level of content protection is illustrated and discussed with respect to method 1100. Method 1100 includes, essentially, three different possible decision paths. In one path, a request for delivery of content internal to an SNET group results in a first level of content protection being applied, a request for delivery of content from outside of the group but within the same SNET results in a second level of content protection being applied, and a request for delivery of content completely outside the SNET results in a third level of content protection being applied. Content can be tagged as part of any selected level of protection.

At block 1103, a determination is made that available content is to be provided to a destination specified in a request for content received at a social device in an SNET group. As illustrated by block 1105, a check is performed to determine whether the requestor and the destination device are members of the same SNET group as the social device from which the content is being requested.

A first decision path is chosen if the determination at block 1105 is favorable, for example if either the requestor or the requested destination device is a member of the same SNET group providing the requested content. In some embodiments a favorable determination at block 1105 results only if both the requestor and the destination device are docked in, or members of, the same SNET group as the social device handling the content request. Other embodiments return a favorable determination if the destination device is docked in the SNET group, but the requestor is not. Yet other embodiments return a favorable determination if the requestor is a member of the same SNET group as the social device handling the content request, even if the destination device is not.

The first decision path continues at block 1117, which illustrates that a check of preferences is performed. The preference check can include a check of system preferences related to a known devices and requestors, such as blacklists or whitelists, preferences related to the use of Virtual private networks, security, trust verification levels, and the like. Other preferences that can be checked include preferences related to group or SNET membership or docking, preferences that an owner, licensee, or other provider of the content established upon making the content available to the SNET group, preferences and DRM requirements associated with particular instances and items of content, tags already included in the content, or the like. As illustrated by block 1119, a first level of protection is selected based on the preference check and applied. The first level of content protection, in at least one embodiment, is selected to take into account that the requestor, or the destination device, is a member of the same group from which the content is requested or provided.

A second and third decision path include block 1107. As illustrated by block 1107, if the determination at block 1105 is unfavorable, for example if neither the requestor nor the destination device are a member of the same group as the social device servicing the content request, a check is made to determine whether either or both the requestor and the destination device are members of the same SNET (but different groups) as the social device from which the content is being requested.

The second decision path shows that if the determination made in block 1107 is favorable, protection preferences associated with SNET members who are not also members of the same SNET group, are consulted to assist in choosing an appropriate second level of content protection. Protection preferences, like those discussed with respect to block 1117, include security, DRM restrictions, user and other preferences that can be stored in an SNET host, a social device, or in a combination thereof, and be used to inform an appropriate selection of a content protection level. The preferences can include, but are not limited to, trust threshold levels, authentication information and challenge questions and answers, preferred content formats, and the like. The preferences can be user-centric preferences—for example lists of allowed users, device-centric preferences—for example a list of device types, platforms, and capabilities required before a device is approved to receive unrestricted content, membership-centric—for example all devices docked in the SNET can receive unrestricted content, or a combination—for example particular content or types of content can be delivered to particular types of devices only if the requestor is a member of the SNET. The preferred second level of content protection is applied at block 1115.

The third decision path is entered if the determination made in block 1107 is unfavorable, for example if neither the destination device in the requestor are members of the same SNET. As discussed above, content protection preferences are consulted at block 1109, and a third level of protection is applied to the requested content before delivery, as illustrated at block 1111. The third level of protection takes into account that the content is being delivered outside of the SNET.

Regardless of the level of protection applied to the content, the content can be tagged prior to delivery, as illustrated by block 1121. Content can be tagged with a time to live tag, a tag limiting the number of copies, a tag limiting distribution based on group or SNET membership, a tag identifying an original source of the content, a tag indicating an original requested destination and requestor, a tag indicating a level of protection applied to the content, or the like.

As illustrated at block 1123, content with the appropriate level of content protection is delivered to the destination device. Note that although not specifically illustrated, both an original version of content and a content version produced in response to a selected security level can be delivered.

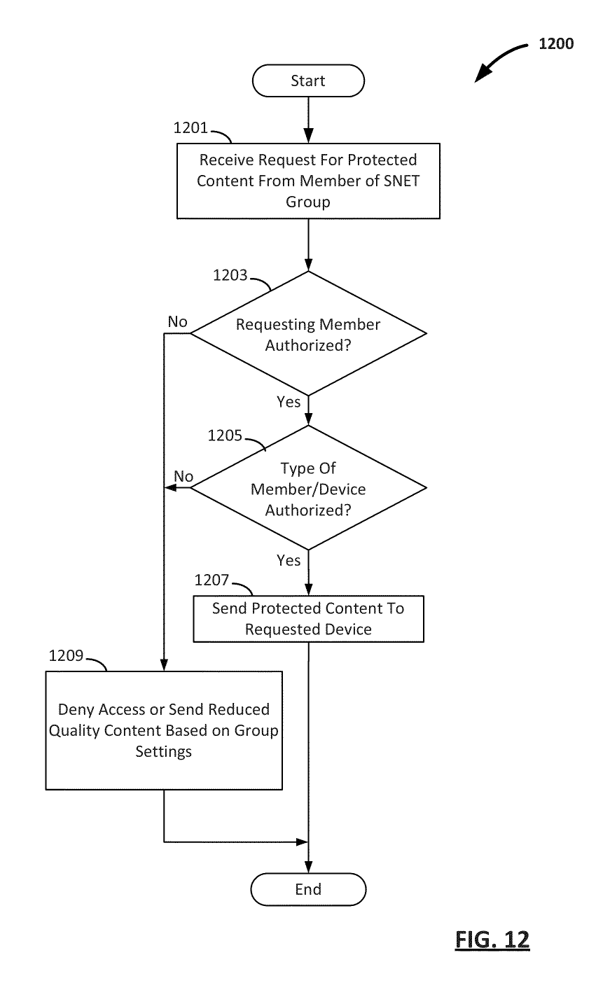

Referring next FIG. 12, a flowchart illustrating a method 1200 used to verify that non group-members are authorized to receive group content, is illustrated and discussed according to various embodiments of the present disclosure. At block 1201, a request for protected content is received from the member of another SNET group, or an entity that is not a member of the current SNET group. In some instances, the request can come from within the same social network, but from an SNET group having a different level of trust. In other instances the request may come from a member of a different social network, or from a device that is not a member of any social network or social network group. For purposes of this example, it can be assumed that the request comes from another member of the same social network but from a different SNET group. The same or similar techniques can be used to handle requests from other sources.

At block 1203, a determination is made about whether members of the SNET group from which the request is received are authorized to access the particular resource requested. Thus, for example, if a request for audio/video content is received from an SNET group having a trust level that is higher or equal to the trust level of the SNET group from which the audio video content is requested, it may be determined that the requestor is authorized to receive the content simply on the basis of the requestor's membership in the other SNET group. If members of the SNET group from which the request for protected content is received has a lower trust level than the trust level of the SNET group holding the protected content, access to the protected content can be denied, as illustrated by block 1209.

In some applications, rather than simply denying the request, reduced quality content, or both a reduced quality version and an original version, can be delivered based on group settings or parameters. Thus, for example, if the requestor is a member of the group that has a limited trust rating, a reduced quality version of the protected content can be sent to the member of the other SNET group. If, however, the requestor is a member of an SNET group having a very low trust level, transmission of the protected content can be denied. Furthermore, method 1200 can be used in conjunction with various standardized digital rights management (DRM) or other content protection standards or schemes without departing from the spirit and scope of the present disclosure.

If it is determined at block 1203 that members of the SNET group from which the request is received are authorized to receive the requested content, an additional check can be made, as illustrated at block 1205, to determine whether the requestor is the type of member or device authorized to receive protected content. For example, even though members of a particular SNET group may be authorized to receive the protected content, there may be a block on sending content to particular types of recording devices. Thus, a digital video disk (DVD) recorder that is a member of an SNET group in which members are generally permitted to receive the protected content may still be blocked from receiving the protected content because of its device or member type.

As illustrated at block 1207, if it is determined that the requestor is a member of an SNET group authorized to receive protected content, and is also of a device or member type authorized to receive protected content, the protected content can be sent to the requesting member. To continue with the previous example, protected content may be permitted only to non-recording devices, regardless of whether group members are otherwise authorized to receive the protected content. Thus, a television display that is a member of the same SNET group to which the previously mentioned DVD recorder belongs, would be permitted to receive the protected content even though the DVD recorder might not be permitted to do so.

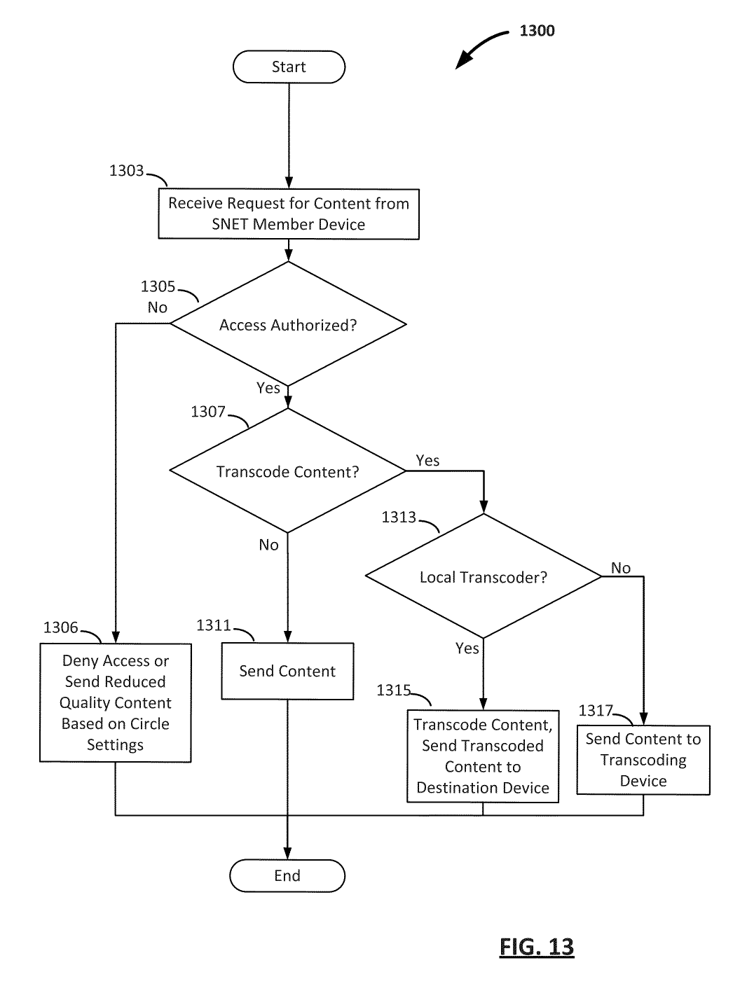

Referring next FIG. 13, a flowchart illustrating a method 1300 used to verify that SNET group-members are authorized to receive group content and determine whether to transcode group content, is illustrated and discussed according to various embodiments of the present disclosure. At block 1303, a request for protected content is received from a member of the current SNET group. At block 1305, a status of the destination device is determined by checking to see if the destination device has been authenticated, authorized, and is trusted. In some embodiments, the status of the requestor is determined prior to selecting the level of content protection. If the requestor's status is unfavorable, that is to say if the requestor is not authenticated, authorized, and trusted, access to the requested content can be denied, or reduced quality content can be provided. In some embodiments, a device is determined to be authenticated, authorized, and trusted based upon its association with the SNET group. For example, where a DRM restriction associated with the requested content restricts access to the content to devices docked with the SNET group, devices associated with members of the SNET group, and the like, determining a status of the requestor can include determining whether the requestor is a member of the SNET group, determining whether a requesting device is docked to the SNET group, determining whether the destination device is docked to the SNET group, determining whether the destination device is associated with a member of the SNET group, some combination thereof, or the like.

At block 1305, a determination is made about whether one or more of the member of the SNET group from which the request is received, a destination device to which the requested resource is requested to be sent, some combination thereof, or the like, is authorized to access the particular resource requested. Thus, for example, if a request for audio/video content is received from an SNET group having a trust level that is higher or equal to the trust level of the SNET group from which the audio video content is requested, it may be determined that the requestor is authorized to receive the content simply on the basis of the requestor's membership in the other SNET group. If members of the SNET group from which the request for protected content is received has a lower trust level than the trust level of the SNET group holding the protected content, access to the protected content can be denied, as illustrated by block 1306.

In some applications, method 1300 can be used in conjunction with various standardized digital rights management (DRM) or other content protection standards or schemes without departing from the spirit and scope of the present disclosure.

If it is determined at block 1305 that one or more of the member of the SNET group from which the request is received, a destination device to which the requested resource is requested to be sent, some combination thereof, or the like are authorized to access the requested content, an additional check can be made, as illustrated at block 1307, to determine whether the requested content should be transcoded to accommodate the request. A determination of whether to transcode can be based upon various information related to one or more of capabilities and characteristics of the destination device, various communication pathways that can be used to send the content to the destination device, which devices docked to the SNET group include transcoders, communication pathways between transcoders and the destination device, communication pathways between a storage location of the requested content and transcoders, some combination thereof, or the like. Capabilities and characteristics of the destination device can include, without limitation, resolution capabilities of the device, content formats supported by the device, processing capabilities of the device, buffering capabilities of the device, memory storage capacity of the device, and the like. Capabilities and characteristics of a communication pathway can include, without limitation, bandwidth limitations of a communication pathway, latency, bit error rate, some combination thereof, or the like.

In some embodiments, a determination to transcode may be made to optimize device capabilities, communication pathway capabilities, or the like. For example, where the destination device is a smartphone that is technically capable of supporting the original resolution of a requested media content item, but at a cost of significant power usage, transcoding to a lower resolution may be determined to be desirable where the smartphone is operating on battery power.

If, as shown in block 1311, the content is not to be transcoded, the content is sent to the destination device along one or more selected communication pathways. In some embodiments, the one or more communication pathways are selected to optimize available processing capabilities of devices docked to the SNET group, processing systems supporting the SNET group, available bandwidth in communication pathways, some combination thereof, or the like.

If, as shown in block 1313, the requested content is to be transcoded, one or more transcoders to transcode the content are identified and selected. As shown in the illustrated embodiment, a determination is made whether a local transcoder is available to transcode the requested content. A local transcoder can include, without limitation, a transcoder that is part of the processing system, device, or the like performing some or all of method 1300. If, as shown in block 1315, a local transcoder is identified, the content can be transcoded and sent to one or more destination devices. If, as shown in block 1317, a local transcoder is not identified, a non-local transcoder that can be utilized to transcode the content may be identified. A non-local transcoder can, in some embodiments, include a transcoder docked to the SNET group, a transcoder that is part of a device docked to the SNET group, a transcoding service provided by a processing system associated with the SNET group, some combination thereof, or the like. If one or more non-local transcoders are identified, one or more transcoders can be selected to transcode the requested content. Transcoders can be selected based upon characteristics of communication pathways between a storage location of the content and the transcoder, characteristics of communication pathways between the transcoder and the one or more destination devices, some combination thereof, or the like. For example, a non-local transcoder may be selected where the bit error rate of a communication pathway between the transcoder and the destination device are less than communication pathways between the destination device and any other identified transcoders. Once a non-local transcoder is selected, the content is sent to the transcoder.

In some embodiments, sending content to a transcoder, destination device, or the like includes sending a command to a storage location to forward an instance of the content to the transcoder, destination device, or the like. For example, where some or all of method 1300 is performed by a processing system supporting an SNET group, and the content is stored in a content storage device docked to the SNET group, the processing system may send a command to the content storage device to send an instance of the stored content item to a transcoder along with instructions to forward the transcoded content to the destination device, send an instance of the stored content item to the destination device via one or more communication pathways, some combination thereof, or the like.

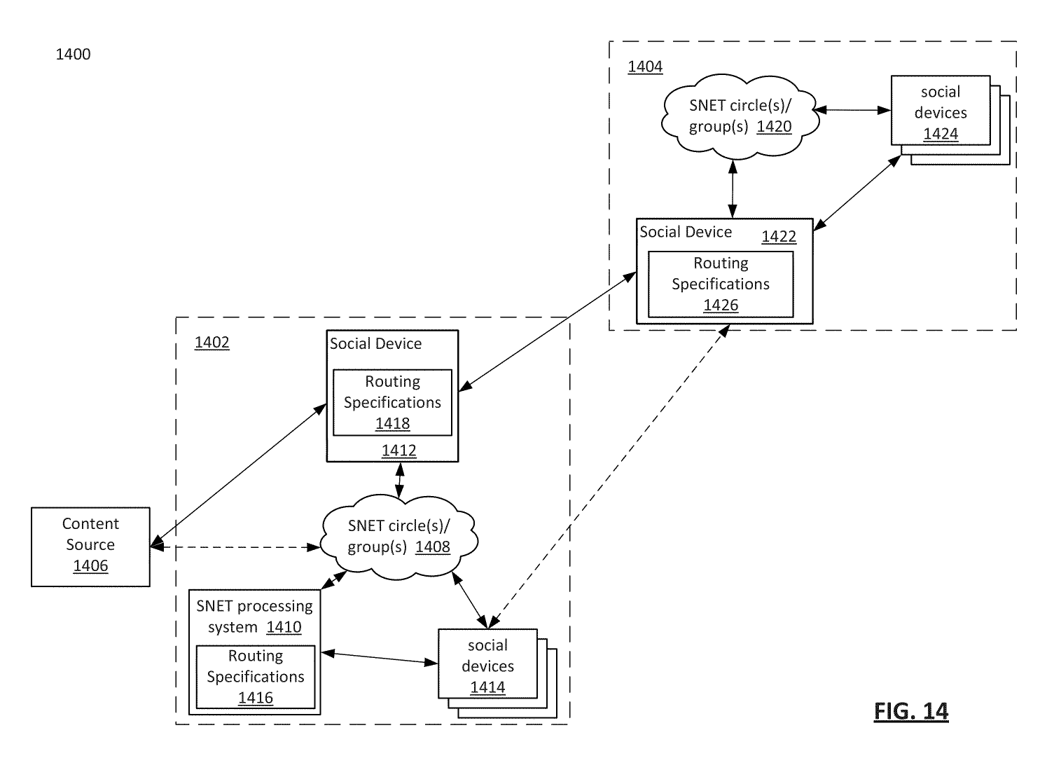

Referring next to FIG. 14, a social networking environment 1400 according to various embodiments is illustrated and discussed. Social networking environment 1400 can include a first SNET infrastructure 1402, a second SNET infrastructure 1404, a content source 1406, and the like. The respective SNET infrastructures 1402 and 1404 can include one or more SNET circles/groups 1408 and 1420, one or more social devices 1412, 1414, 1422, and 1424 that are docked to SNET groups within their respective SNET infrastructures, one or more SNET processing systems 1410 supporting one or more SNET groups 1408, and the like.

In some embodiments, content received at a first SNET infrastructure can be routed to a second SNET infrastructure based upon one or more routing specifications. Such routing can be used by some part of the first SNET infrastructure to leverage an indirect link to the second SNET infrastructure via the first SNET infrastructure for various content received from a content source external to the first SNET infrastructure. Such leverage can include charging a fee to various content sources to route content received from the sources to various other SNET infrastructures. For example, a corporate recruiter entity using social device 1412 may have a predetermined association with an SNET infrastructure 1404 of a corporation, such that the recruiter routes certain recruiting-related content received from various sources 1406 to a device 1422 in the corporation's SNET infrastructure. The recruiter may charge a fee for the routing service, receive a commission for deals made as a result of the routing of the content to the corporation, some combination thereof, or the like.

In some embodiments, routing is managed on a device-by-device basis. For example, social device 1412 may include a routing specification 1418 that manages routing of content received at social device 1412 to a selected social device 1422. Such routing can proceed directly between social devices 1412 and 1422, via an intermediary device 1414 that is linked to social device 1412 via a common docking to SNET group 1408, some combination thereof, or the like.

In some embodiments, a routing of content between infrastructures can enable interactions between two entities that are related only through an intermediary based upon routing of signals through the intermediary. For example, where a first gamer attempts to broadcast a request to interact with a user associated with SNET group 1408, but the user is not active (e.g., is asleep or otherwise indisposed), SNET processing system 1410 can route the interaction request to another device 1422 supporting a second gamer, where the second gamer is associated with the user but not the first gamer. In this manner, an interaction request can be forwarded to a “friend of a friend” based upon various routing specifications, as discussed further below.

In some embodiments, some part of a first SNET infrastructure can transcode content to be routed to another SNET infrastructure, SNET group, or the like. For example, social device 1412 can include a transcoder that can transcode content received from content source to accommodate a social device 1422 to which the received content is to be routed. Such transcoding can be leveraged by a member supported by the device, processing system 1410, or the like, to charge a fee for the transcoding and routing of the content.

A routing specification can govern routing and transcoding content between selected devices, SNET groups, and the like in separate SNET infrastructures. Routing specifications can govern routing between all devices docked to an SNET group, one or more selected devices in one or more SNET groups, or the like. For example, as shown in the illustrated embodiment, SNET processing system 1410 supporting SNET group 1408 can include routing specifications 1416, which can manage routing of all content generated in SNET infrastructure 1402, received from an external content source 1406, or the like to various devices docked to another SNET group 1420 that is part of another SNET infrastructure 1404. As another example a routing specification supporting device 1412 can manage routing of content received by device 1412 to one or more devices 1422 docked to a separate SNET group 1420. In another example, a routing specification 1426 can manage routing of content received from another SNET infrastructure 1402 to other devices 1424 docked to a common SNET group 1420 with device 1422.

In some embodiments, a routing specification is created by a device, processing system, or the like based upon internal logic. For example, SNET processing system 1410 may create one or more routing specifications 1416 that route content items of a first type received by a device 1412 of SNET infrastructure 1402 to devices of SNET infrastructure 1404 with which the device 1412 has historically sent content items of the first type. In another example, SNET processing system 1410 may create a routing specification 1416 that routes content pushed to SNET group 1408 to one or more devices docked to SNET group 1420 via one or more docked devices 1412 and 1414 based upon common preferences between SNET group 1408 and SNET group 1420.

In some embodiments, a routing specification is created, modified, and the like based upon input from one or more members associated with an SNET infrastructure. For example, routing specification 1418, which may govern routing, by social device 1412, of content received at social device 1412, SNET group 1408, some combination thereof, or the like, based upon preferences provided by a member supported by the social device 1412. Such preferences may include routing any content received at social device 1412 only to social device 1422, routing any content received at social device 1412 to all devices docked to SNET group 1420, routing only selected types of content received at social device 1412 to selected social devices 1422, some combination thereof, or the like. In some embodiments, device-specific routing specifications can be managed by a processing system supporting some or all of an SNET infrastructure, SNET group to which the device is docked, or the like. For example, when social device 1412 is active and interacting with SNET infrastructure 1402, content received at SNET infrastructure 1402 that is directed to social device 1412 may be routed by social device 1412 to social device 1422 based on routing specifications 1418 stored on social device 1412. When social device 1412 is inactive, content received at SNET infrastructure 1402 that is directed to social device 1412 may be routed by SNET processing system 1410 to social device 1422 via one or more social devices 1414 based on routing specifications 1416 accessible to processing system 1410. Routing specifications can include as-of-this-date copies of routing specifications 1418, which may be collected from social device 1412 on a periodic basis, continuous basis, as-updated basis, intermittent basis, some combination thereof, or the like.

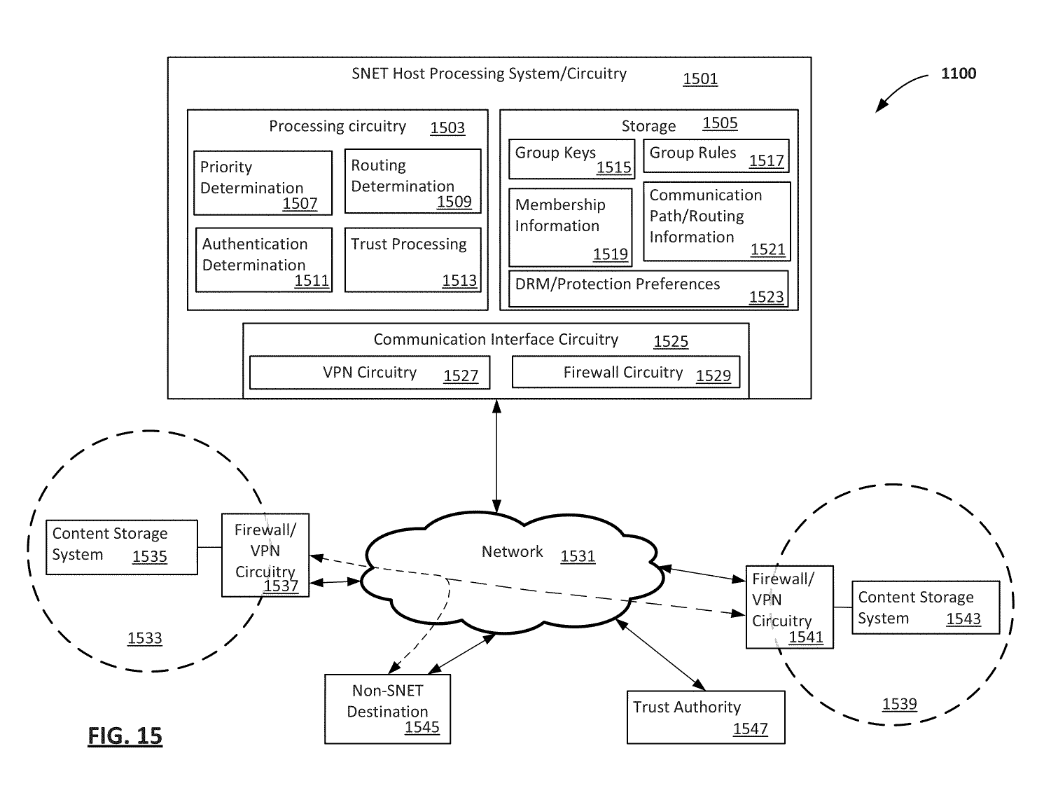

Referring next to FIG. 15, a system 1500 including SNET host processing system/circuitry 1501 is illustrated controlling transmission of shared content between SNET groups 1533 and 1539, and from within SNET groups 1533 and 1539 to a destination device external to both SNET groups 1533 and 1539. In some embodiments SNET host processing system/circuitry 1501 can be used to select an appropriate level of content protection for shared content, and to select routes, or presentation pathways, for delivering requested content. In the illustrated embodiment SNET host processing system/circuitry 1501 can facilitate transmission of protected content without having access to the content itself. In other embodiments, SNET host processing system/circuitry 1501 can access the content being transmitted, and is able to encode, encrypt, decode, decrypt, watermark, transcode and otherwise process shared content as necessary for delivery according to a selected security level to be applied to the shared content. The continued security of the presentation pathway can be verified by periodically, or in response to a change in security characteristics, issuing challenges to social devices, services, and communication devices.

SNET host processing system/circuitry 1501 includes processing circuitry 1503, storage 1505, and communications interface circuitry 1525. The processing circuitry 1503 can include priority determination module 1507, routing determination module 1509, authentication determination processing module 1511, and trust processing module 1513. Storage 1505 can include group key storage 1515, storage for group rules 1517, membership information storage 1519 communication path routing information 1521, and storage for DRM protection preferences 1523. Communication interface circuitry 1525 can include VPN circuitry 1527 and firewall circuitry 1529.

SNET host processing system circuitry 1501 can communicate with various social devices in SNET groups 1533 and 1539 via a network 1531. Each of SNET groups 1533 and 1539 can include firewall/VPN circuitry 1537 and 1541 to facilitate secure communications between SNET host processing system/circuitry 1501 and the content storage system 1543 and 1535. In various embodiments, SNET host processing system/circuitry 1501 can be implemented in a social device in either group 1533 or 1539, in a social device belonging to an SNET that incorporates groups 1533 and 1539, or in a server system. In some embodiments, SNET host processing system circuitry 1501 can be implemented in a temporary, ad hoc manner in one or more suitable devices docked within, or otherwise having access to, the appropriate social network or social network group.

Priority determination module and circuitry 1507 can be used to establish an order in which content is provided to various requestors, destinations, or combinations of requestor and destination device. Thus, for example, requests from a requestor within the same group to which SNET host processing system circuitry 1501 belongs may be granted a higher priority than a requestor outside of that group, resulting in faster delivery of content within a particular SNET group. Likewise, requests from certain requestors may be granted a higher priority than requests from other requestors. Likewise, priority may be given to particular destination devices, or to all destination devices within a particular SNET group.

Priority determination module and circuitry 1507 can use DRM/protection preferences 1523, communication path/routing information 1521, membership information 1519, and other information from storage 1505 to assign a priority and security level to one or more transfers of protected content. In some embodiments, the priority determination module and circuitry 1507 can also receive input from content storage systems 1543 or 1535, or from an owner of those content storage systems, indicating a priority to be assigned. Using the input from the content storage systems, or the owner of the content storage systems, can provide a mechanism for load balancing. And in some cases, for example, where content storage system 1535 is used by a member of SNET group 1533 to both store and consume shared content—for example a wireless phone—the member can lower a priority assigned to a request for shared content, thereby preserving enough bandwidth or processing resources to ensure that the member's consumption experience is not diminished by his sharing of content.

Routing determination module circuitry 1509 can be used to determine a pathway by which content is to be delivered from one of the content storage systems 1535 or 1543 to a requested destination device. The determination can be based on whether SNET host processing system circuitry 1501 is to simply broker the request, or whether content is to be transmitted through SNET host processing system circuitry 1501. So, for example, if a social device belonging to an SNET group 1533 requests content from content storage system 1535, routing determination module 1509 can instruct content storage system 1535 to deliver the content directly to the requestor or the requested device. Delivery of content in this manner may not require the content to be provided to SNET host processing system/circuitry 1501, although in some circumstances content may be delivered to SNET host processing system/circuitry 1501 for delivery to the desired destination.

The routing determination can take into account the DRM access rights of various devices in the selected path, sometimes referred to herein as DRM chaining, and set a level of security based on not only the endpoint devices, but also the DRM access rights and trust levels of intermediate nodes. In this way, if the originating device and the destination device are determined to have the proper DRM access rights and trustworthiness, a path including more trustworthy devices can be selected over a path including less trustworthy devices. In some instances, transfer of protected content over a less secure pathway can trigger higher security requirements than would otherwise be required.

A non-SNET destination 1545 can receive content from content storage system 1535 or 1543 directly, via paths illustrated by the dotted lines, as directed by routing determination module 1509. Alternatively, routing determination 1509 may determine that content storage system 1543 is to deliver the content indirectly to non-SNET destination 1545, by first transmitting the content to SNET host processing system circuitry 1501, and then having SNET host processing system circuitry 1501 deliver the content to non-SNET destination 1545.

Authentication determination module 1511 can be used to determine whether or not a requestor or a destination device has been authenticated and authorized to receive requested content. Trust processing system 1513 can be used in combination with trust authority 1547 to determine whether a content requestor or a requested destination device, such as non-SNET destination 1545, is trusted. Authentication determination module 1511 and trust processing circuitry and module 1513 can be used in conjunction with each other to determine a level of content protection to be applied to shared content being transmitted to a destination device. The determined level of content protection can be used to decide whether content should be tagged, watermarked, transcoded, or whether some other form of content protection should be implemented.

In some embodiments, authentication determination module 1511 and trust processing circuitry 1513 may determine that content storage system 1535 and content storage system 1543 are required to deliver content to SNET host processing system/circuitry 1501 for application of a desired level of content protection. In other instances, authentication determination module 1511 and trust processing module 1513 can inform content storage systems 1543 and 1535 of their determinations, and allow the content storage systems to apply the correct level of content protection. Content storage system 1535 can also deliver content to another social device for proper application of the selected content protection scheme level. For example, if content storage system 1535 is a less-sophisticated storage device, while content since storage system 1543 includes more advanced functionality, SNET host processing system/circuitry 1501 can instruct content storage system 1535 to deliver the shared content to content storage system 1543, which in turn applies the correct level of protection, for example watermarking, prior to providing the content to non-SNET destination 1545. In various embodiments, content storage systems 1535 and 1543 can incorporate some or all of the functionality of SNET host processing systems/circuitry 1501.

Storage 1505 includes storage for group keys 1515, which allows SNET host processing system/circuitry 1501 to communicate with multiple different groups using respective group keys. Storage 1505 can also include storage for group rules 1517. Group rules 1517 can, in some instances, be stored in conjunction with content, or pointers to content, so that when particular content is requested, group rules 1517 can be used to assign an appropriate level of content protection. So, for example, group rules for group 1533 may indicate that any content requested from within group 1533 can be sent only to SNET members or devices docked within an SNET group 1533 or 1539, while rules for group 1539 can indicate that content storage system 1543 can deliver content to any destination device, regardless of group membership, so long as a threshold level of trust is met, and the content is watermarked or transcoded to reduce its resolution to a preferred level. Group rules 1517 can also specify particular levels of protection based on DRM licensing information, and may include licensing information associated with various members of the SNET group or groups being hosted.

Membership information 1519 can include information relating to the membership or trust status of particular devices or particular groups, associations of devices with human members, blacklists, white lists, licenses, or the like. The membership information can be used in conjunction with other information to assist in selecting a level of content protection to apply to shared content. Communication path routing information 1521 can include information such as IP addresses for storage content systems 1535 and 1543, information associated with the number of hops between member devices, the type of communication pathways between SNET host processing system/circuitry 1501 and various social devices, which paths are capable of implementing VPNs, and which devices are included behind firewalls circuitry 1529.

DRM protection preferences 1523 can be associated with a device, types of devices, a user, particular content or instances of content, DRM licenses or license types, and the like, thereby enabling the SNET host processing system/circuitry 1501 to determine a preferred type of content protection to apply to requested content, to content requested by particular requestors, to content requested by a particular class of requestors, to content requested to be delivered to a particular device, to a particular class of devices, to particular device statuses, to devices within particular SNETs or SNET groups, to devices having a particular trust level, and so on. Authentication determination 1511, trust processing 1513, routing determination 1509, and priority determination 1507 can all use DRM protection preferences 1523, communication path routing information 1521, membership information 1519, group rules 1517, and group keys 1515 in determining whether or not to provide content to particular destinations, whether or not to provide content in response to requests by particular requestors, and the type and level of content protection to apply.

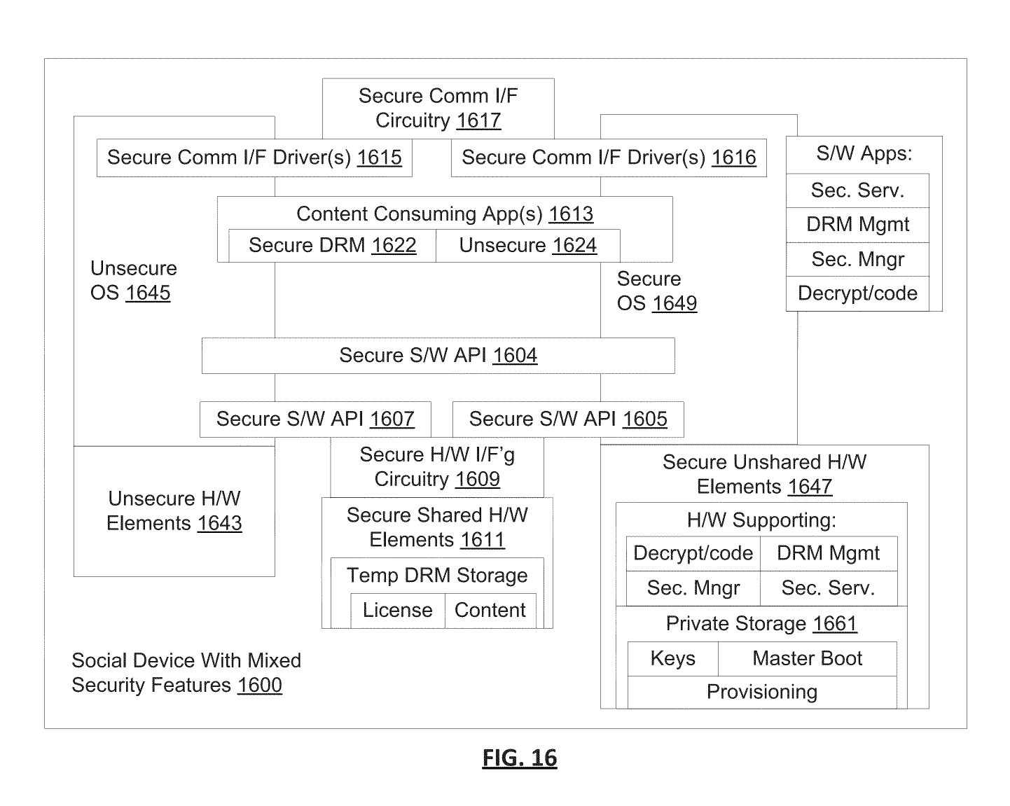

Referring next to FIG. 16, a social device 1600 including mixed security features is illustrated and discussed according to various embodiments of the present disclosure. Social device 1600 can be contained within a housing such as a set top box, a wireless phone, a tablet computer, a server box, a Network-Attached Storage (NAS) storage device, a gateway, access point, or other device used to implement a social network or docked to a social network. Social device 1600 includes both secure and unsecure elements, each of which can be included in presentation pathways when docked to a corresponding security group within an overall social group. For example, unsecure operating system 1645 and unsecure hardware elements 1643 can be used to run, install, and access applications, services or content, such as publicly available software and public domain content that requires little or no DRM protection. When social device 1600 is running in an unsecure mode, secure communications interface circuitry 1617 and secure communication interface drivers 1615 and 1616 prevent unsecure operating system 1645 and unsecure hardware elements 1643 from accessing the secure portion of social device 1600.

The highly secure portion of security device 1600 includes secure operating system 1649 secure hardware elements 1647. The secure operating system 1649 and the secure hardware elements 1647 are separate from, and unshared with, the unsecure operating system 1645 and hardware components 1643, thereby permitting protected content to be downloaded, executed, viewed, or otherwise operated upon while still maintaining a security level dictated by a data rights manager, or as otherwise established by an SNET or SNET group. Secure unshared hardware elements 1647 can include hardware that supports or implements decoding and decryption, DRM management, secure services, and a security manager, the functionality of which has been previously discussed.

Secure unshared hardware elements 1647 can also include private storage 1661, implemented in segmented or otherwise protected memories, which can be used for storing information such as public and private keys, group keys, SNET keys, licensing keys, master boot firmware, provisioning firmware and software, or the like. By preventing unsecured portions of security device social device 1600, from accessing the secure hardware elements 1647, the security of the secured portion can be more easily maintained by preventing unauthorized or undetected tampering. For example, the secure, unshared hardware elements 1647 can include secure interfaces, such as secure hardware interfacing circuitry 1609. Tamper proofing and detection devices can also be used to help ensure hardware integrity, for example, by identifying security breaches within a housing, or rendering private storage unusable if physical access to the private storage internal workings is obtained. In some embodiments, tampering alters the functionality or data stored in secure hardware elements 1647 without rendering the hardware unusable, for example, by automatically setting particular bits in the memory to a desired value if tampering is detected, or deleting certain keys or other portions of the memory in response to detection of tampering. In some embodiments, tamper detection for secured hardware elements 1647 can be implemented by automatically sending a tamper indication to a social network host in response to tampering being detected.

The secure portion of social device 1600 can also include secure software applications, which can be used to implement secure services, e.g. billing; DRM management services, e.g. determining, configuring, and enforcing DRM security protocols and procedures; a security manager function, which can be used to perform various self monitoring and other security functions; and decryption, decoding, encryption and encoding. In some embodiments, the secure software can be loaded into secure memories during manufacture of security device 1600, and require a secure update procedure to be performed by an authorized technician. In some cases, secure software applications can be installed or updated by providing an authorization code to an owner of social device 1600 via a social network to which social device 1600 is docked. The secure software can, in some cases, be managed by a social device host or secure social device.

In general, secure software is executed using the secure operating system 1649. This allows sensitive content requiring high security, to be played back, installed, or accessed using the secure portions of social device 1600. So, for example, a social device with mixed security features can execute, install or access protected content using secure operating system 1649 and secure unshared hardware elements 1647, thereby preserving the security of the content. Also generally, content can be accessed, installed, executed, or played back using unsecure operating system 1645 and unsecure hardware elements 1643 if the content is tagged, watermarked, transcoded, or otherwise has safeguards included in the content itself. At least in part because the two portions of social device 1600 remain separate, content can be provided to social device 1600 using a first level of security suitable for highly secure content, despite the fact that portions of social device 1600 may not be secure enough to receive the same content.

To help maintain the separation between the secure, unshared portions of social device 1600 and the unsecure portions, secure operating system 1649 and unsecure operating system 1645 interface with each other via secure interface communications circuitry 1617 and secure communication interface drivers 1615 and 1616. The secure communication interface circuitry 1617 and drivers 1615 permit one-way access by secure operating system 1649 to unsecure operating system 1645, thereby allowing the secure portion social device 1600 to receive services and use general communications or other processing resources available in social device 1600 without requiring that the entire social device 1600 be secured.

Secure operating system 1649 can also communicate with unsecure operating system 1645 via a secure software APIs 1604, 1605, and 1607. Secure software API 1604 can be run on top of secure OS 1649 using secure, unshared hardware elements 1647, and allow unsecure OS 1645 to send requests to secure OS 1649 and to respond to requests from secure OS 1649. In other embodiments, secure software API 1607 and secure software API 1605 are executed by shared hardware interfacing circuitry 1609, resulting in communications between secure OS 1649 and unsecure OS 1645 being handled by shared secure shared hardware element 1611. Secure shared hardware elements 1611 can include temporary DRM storage for licenses, and temporary storage for protected content. Although secure shared hardware elements 1611 may not be as strictly secured as unshared secure hardware elements 1647, similar security measures can be employed to prevent and detect tampering.

Social device 1600 can be implemented in various different hardware nodes, regardless of whether the node is a requesting device, a receiving device, or an intermediate node through which protected content will be transferred. In some embodiments, social device 1600, through the shared secure hardware elements 1611, can be authorized store content that is watermarked tagged or otherwise protected, and secure software application interface 1607 allows playing of the secure content stored in the shared secure hardware elements 1611, although the unsecure operating system may not be authorized to retransmit content stored in the secure shared hardware elements 1611.

Consider the following example of social device 1600 in operation. A user of social device 1600, which is a wireless tablet device in this example, desires to view a newly released movie. Assume for purposes of this example that unsecure portion of social device 1600 is docked to a middling security level of an SNET, and that the middling security level will allow a maximum resolution playback of the movie for a period of 1 day, so long as an appropriate license is purchased. Also assume that the secure portion of social device 1600 is docked to a highly secure sub group of the SNET. Social device 1600 sends a request to a movie delivery service, which is docked to the same highly secure sub group as the secure portion of social device 1600. The secure OS 1649 sends encrypted messages, via secure communication interface circuitry and drivers 1616, 1617, and 1615 to an SNET host providing the services illustrated in FIG. 11. The SNET communicates with secure OS 1649 to arrange billing for the movie, and sends the necessary license key to secure OS 1649. Software applications running on secure OS 1649, and using unshared hardware elements 1647, handle the billing, decryption, DRM management, and the like.

Secure OS 1649 sends the necessary license keys to temporary DRM storage in secure shared hardware 1611, Secure OS 1649 can also obtain the protected content from the movie service using the license key provided by the SNET host. Once the content and key are stored by shared hardware elements 1611, the secure OS 1649 sends the unsecure OS 1645 a message via secure software API 1604 indicating that the license key and content are present.

Unsecure OS 1645, using secure software API 1607, obtains the license key from Temp DRM storage, and using secure DRM content consuming application 1622, retrieves and plays back the content stored in temporary DRM storage. In at least one embodiment, the content stored in Temp DRM storage is stored in an encrypted format, and the secure DRM content consuming application 1622 can use the DRM license key to decrypt the content for playback. Secure software API 1607 can be configured to prevent unsecure OS 1645 from writing to temp DRM storage, thereby preventing corruption of the stored content, removal of tags and watermarks, etc. Furthermore, secure DRM content consuming application 1622 can be configured to essentially stream the content from Temp DRM storage, thereby making it more difficult to redistribute protected content.

Unsecure OS 1645 can use unsecure content consuming application 1224 to request, configure, and playback unsecured content without interacting with either shared secure hardware 1611, or secure unshared hardware elements 1647. Note that content consuming applications 1613 can be run on either or both secure OS 1649 or unsecure OS 1645.

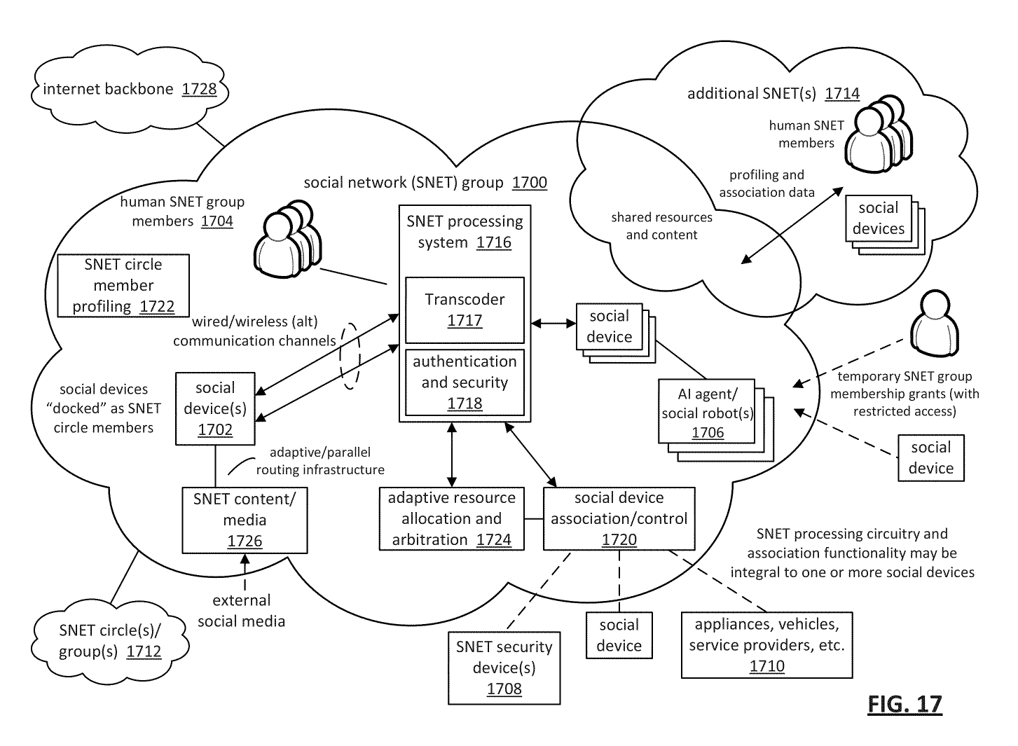

Referring now to FIG. 17, a social network group 1700 (hereinafter “SNET group”) suitable for implementing various embodiments discussed herein, is illustrated and discussed. Briefly, membership in the SNET group 1700 may comprise docked social devices 1702 and human SNET group members 1704, as well as proxies thereof. Further, nodes in SNET group 1700 may include device services and software (e.g., applications) of various types, which participate as members. By way of example, SNET group members might include artificial intelligence agents/social robots 1706, SNET security device(s) 1708, appliances, vehicles and service providers 1710, common or authorized members/functionality of other SNET groups 1712, etc. Further, access to specific content and resources of a SNET group 1700 may be shared with members of additional SNET(s) 1714, including remote or web-based applications. Such access can be conditioned on acceptable profiling and association data. Similarly, social devices or individuals may be granted temporary or ad hoc memberships, with or without restricted access, and in some cases based on one or more levels of trust.

In the illustrated embodiment, formation, maintenance and operation of SNET group 1700 can be performed by one or more standalone or distributed SNET processing systems 1716, processing circuitry and software, or the like. It is noted that the “SNET processing system” may comprise one or more instances of hardware, software, applications, or various combinations thereof, and be configurable to support various functionalities disclosed herein. Further, the SNET processing system 1716 may be included in a standalone server, server farm, cloud-based resources, and/or the various types of devices described below, and incorporate authentication and security functionality 1718, including various embodiments that incorporate device security and trust functionality as illustrated and described in the following figures and accompanying description, and incorporate transcoding functionality 1717. In some embodiments, a SNET processing system may comprise one or more instances of server devices, network nodes, computing devices, and the like. In addition, specialized middleware may also be utilized by SNETs according to the invention, including standardized middleware with an associated certification process. Interactions and interdependencies within the SNET group 1700 may involve one or more of a social device association/control module 1720, SNET group member profiling module 1722, and an adaptive resource allocation and arbitration module 1724 as described more fully below.

Distribution of internal and external SNET content/media 1726 can be accomplished in a variety of ways in accordance with various embodiments. For example, media distribution may involve an adaptive or parallel network routing infrastructure involving a wide variety of communication protocols and wired and/or wireless communications channels. SNET content/media 1726 may comprise, for example, various user-driven (advertising) channels, pictures, videos, links, online text, etc. Access to such content, as well as communications with and remote access to social devices 1702 of the SNET group 1700, may occur over an Internet backbone 1728, cellular communication system, WAN, LAN, etc.

SNET group 1700 facilitates sharing of content and interaction between group members. For example, if one member of social group 1700 is watching a movie, and another member of social group 1700 wants to participate along with the other member, SNET processing system 1716 can be used to determine a level of allowed participation by consulting user preferences, user and device security and trust levels, content licenses, group policies, and the like. For example, SNET processing system 1716 can determine that the second member is permitted to begin viewing the same movie, at the same point in the movie, just as if the second user was watching the movie with the first user in person. Being able to join a movie or other similar content already in progress can provide more personal connections via the social network. The second user might also be able to communicate with the first user via chat or text.

In another example, a user may have set notification alerts within the social network indicating that the user wants to be notified any time another user is playing a video game. SNET server 1716 can be used to verify billing, access rights, and personal preferences of both users, and based on the verifications, permit the user to join the video game already in progress, and allow the two members to communicate via video/audio, or a combination thereof, so that the two users can play the game together. In some such instances, the SNET itself can hold the license to the video game, and be permitted to distribute a set number of concurrent players without additional cost. Furthermore, the security and trust verifications performed by SNET processing system 1716 can be used to ensure that DRM protected content remains protected.

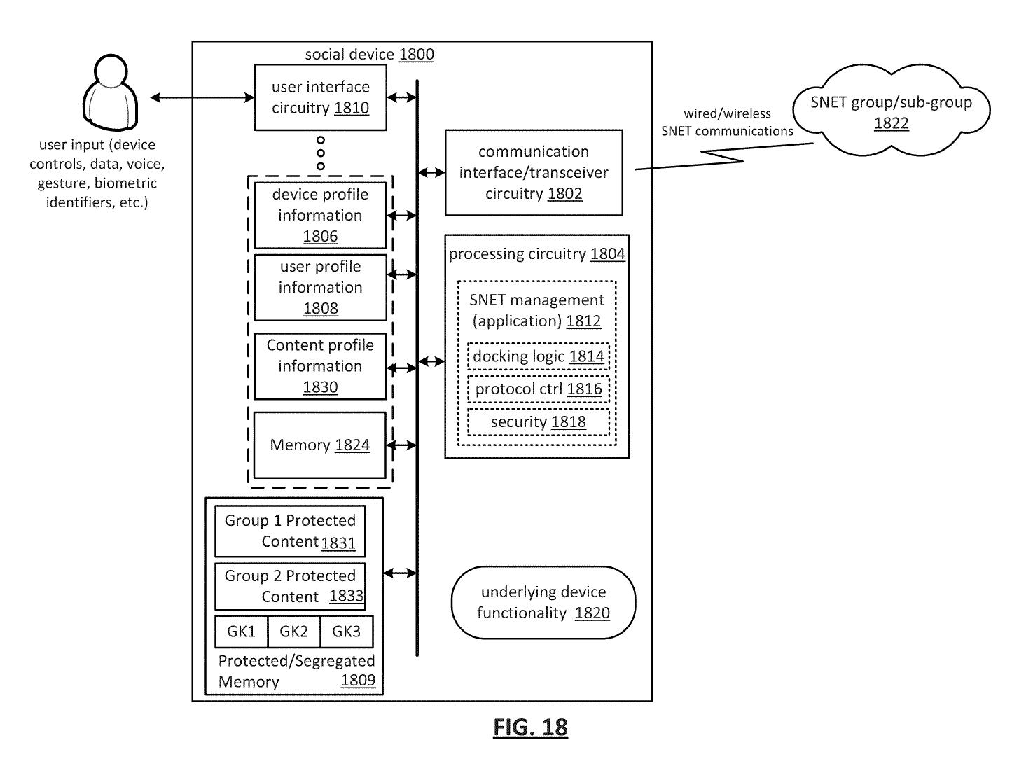

FIG. 18 is a schematic block diagram of an exemplary social device 1800 comprising integral functionality operable to support social network group/sub-group membership and communications in accordance with the invention. In at least one embodiment, social device 1800 can be implemented as a social server. In the illustrated embodiment, a communication interface and transceiver circuitry 1802 is operable to perform wired or wireless communications between social device 1800 and an SNET group/sub-group 1822 over one or more communication channels. Depending on the capabilities and configuration of the social device 1800, communications with an SNET may be unilateral or bidirectional/interactive, and utilize either a proprietary or standardized communication protocol. In some embodiments, a member or resource within an SNET group can accesses a server, social device, or group resources such as an Internet-based resource identified by a URL reference, associated with a second, secure SNET group or sub-group.

The social device 1800 further includes processing circuitry 1804 operable to process and manage communications, services and associations between the device and other entities including members of an SNET group 1822, third parties, software agents, etc. More particularly, the processing circuitry 1804 may include, for example, a software management application 1804 comprising one or more of docking logic 1814, communication protocol control 1816 and security/authentication functionality 1818.

The social device 1800 further may utilize profile information that can take many forms and be maintained in a static or dynamic memory, such as memory 1824. Such profile information enables a social device and/or user to present an image of itself and its capabilities to other members of an SNET. As described more fully below, device and user profile information 1806 and 1808 may be utilized in various ways in accordance with the invention to facilitate a variety of social interactions. Content profile information 1830 can be used to store user preferences related to particular content instances, items, or types, and can be used in selecting an appropriate level of content protection for content provided by social device 1800. Depending on the capabilities and requirements of a particular device (and other members of an SNET), a device or user profile may be static or dynamic.

In addition to memory 1824, social device 1800 can include protected memory 1809 to implement a keystore, or to store other sensitive information. For example, protected memory 1809 can be segmented and used to store keys CK1, CK2, and CK3 or other group secrets associated with multiple different SNET groups with which the social device interacts.

In some embodiments, portions of protected memory 1809 are dedicated to interactions and information to be shared within, but not always between, different groups. For example, protected memory 1809 can be segregated to store protected content associated with group 1 in memory portion 1831, protected content associated with group 2 memory portion 1833. The groups with which each memory portion is associated can belong to the same or different social networks. Furthermore, although not specifically illustrated, multiple different SNET groups can use different profile information, so that device profile information 1806, user profile information 1808, and content profile information 1830 can also be stored in a protected, segregated memory that allows information associated with any particular SNET group to be used substantially only in conjunction with communications related to that SNET Group.

In certain embodiments, the social device 1800 interacts with a user(s) via user interface circuitry 1810. User input to the social device 1800 may include, for example, data entry through a keypad, touchscreen, remote control device, gaming controller, device control buttons, voice or gesture commands, storage device, etc. Authorized access to or control of the social device 1800 can be facilitated through unique biometric identifiers, passwords, token-based identification, trusted authorities or documents such as a driver's license or passport, and like authentication means.

Social device 1800 also performs core or underlying functionality 1820, various examples of which are described herein. Alternatively, the social device may primarily function as a social networking interface or communication device, or be programmable to perform specific functions within an SNET group/sub-group.

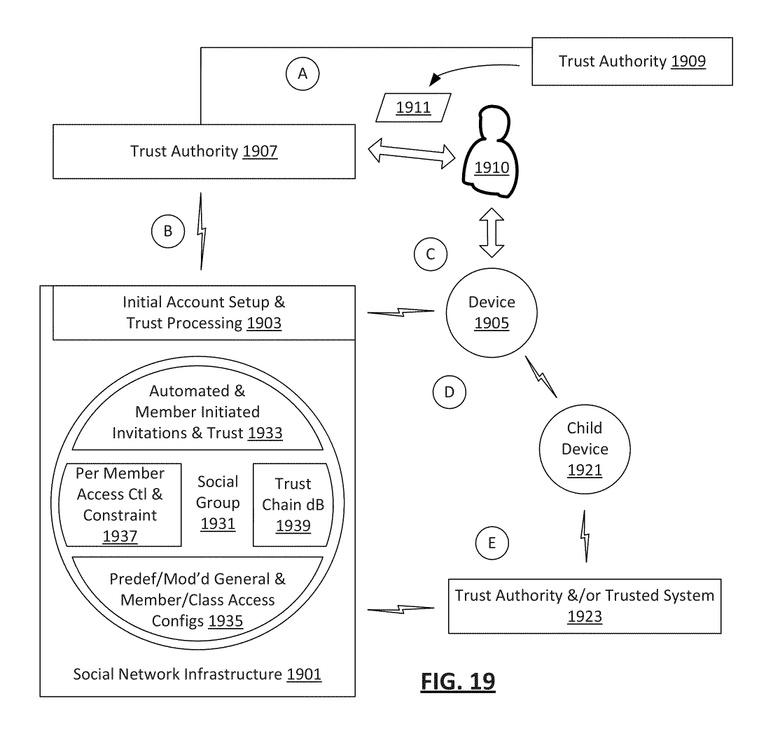

Referring next to FIG. 19, the concepts of trust and trust chain links used by various embodiments to assign or select an appropriate level of content protection are discussed with reference to social network infrastructure 1901. Social network infrastructure 1901 includes initial account setup & trust processing module 1903, and various resources used to implement trust rules, control access to, and otherwise facilitate functioning of a social group 1931. The resources include invitations and trust module 1933, trust chain module 1935, per-member access module 1937, and access configurations module 1935. Social network infrastructure 1901 is connected via a communications link with trust authority 1907, which itself is in communication with trust authority 1909, and trusted system 1923. Trust authority 1907, trust authority 1909, and trusted system 1923 cooperate with each other to establish, verify, and adjust one or more trust levels associated with SNET members, such as human member 1910, device 1905, and child device 1921, SNET groups, SNET chains, and the like. The various trust authorities and trusted systems can also be used to verify the trustworthiness of other trust authorities and systems, regardless of membership in a particular SNET or SNET group.

Also illustrated in FIG. 19 are trust chain links A-D. Trust chain link A illustrates a trust link from a pre-established trust relationship between human member 1910 and trust authority 1909, for example a birth certificate. Using either a direct communication or via an intermediate document, e.g. the birth certificate, human member 1910 can extend the trust chain via another trust authority 1907, e.g., passport, driver's license service). This can be achieved through an electronic communications link, such as a wireless link, via staff to staff communication between trust authority 1907 and trust authority 1909, or both, plus interaction with human member 1910 or a trusted document 1911, for example a driver's license, passport, etc.

Visual and description information, including age, gender, weight, height, address, social security numbers, “freshness” date, or the like, can also be delivered from trust authority 1907 to trust authority 1909. This information can receive another layer via the trusted authority 1907 as it interacts with human member 1910, either providing “fresh” confirmation or adding a superseding entry. Other sources can also be used to verify each of the elements of information transmitted between trust authority 1907 and trust authority 1909.

After interacting with trust authority 1909 and human member 1910, trust authority 1907 establishes a trust rating for human member 1910, which indicates whether or not any information given seems in conflict or unusual. For example, a trust rating of 80% may be given to human member 1910, indicating that there is an 80% probability that the associated trust information is correct.

Specific resolution regarding why the rating is not higher or lower, may be tied to trust ratings of specific pieces of information used to establish the overall trust level. For example, a passport with visual face recognition correlation with human staff confirmation that the person present plus the passport photo are likely the same person might yield an 85% confidence level that the person is who they say they are. A comparison of hospital recorded biometric information obtained at the time human member 1910 was born, for example an iris print, fingerprint, or other information, with corresponding information obtained at the present time from human member 1910 might yield a much higher confidence level, for example 95%. The missing 5% might involve elements further up the chain, e.g., the trust link associated with the hospital and its staff.

Once human member 1910 becomes trusted, for example through the interactions just described, he may attempt to interact with social network infrastructure 1901 through device 1905 to establish an account via initial account setup & trust processing module 1903. Note that the communication links illustrated between various devices can include one or more wired or wireless communication networks or links along with any needed bridging, routing and access nodes between those devices.

When setting up the account, human member 1910 can provide information identifying himself and other associated information. From such information, initial account setup & trust processing module 1903 interacts with the trust authority 1907, either at the same time or post facto, to gather trust information and ratings of 1907. These ratings can be used by initial account setup & trust processing module 1903 to establish its own trust ratings, and construct challenge questions that will be used to challenge human member 1910 via device 1905. Overall, from such queried interactions, information received from trust authority 1907, information received directly from human member 1910 via device 1905, and received trust ratings, new trust information and updates can be generated and stored in one or more of trust chain database 1939, access control 1937, invitations and trust 1933, and access configuration 1935. The trust ratings, updates, and other information can also be communicated in whole or in part back to trust authority 1907 for storage or distribution to other storage locations.

Note that in various instances, when generating adaptive trust ratings, newer data may be overlaid onto the older data without producing or replacing the older data, at least to an extent permitted by storage. Overlaying the data permits newer data and older data to be taken into account, given different weightings based on currency of the information, and allows an overall trust rating to settle at a particular level over time.

At this point, human member 1910 has established a trust rating and trust relationship with social network infrastructure 1901, but device 1905 is not yet trusted. This can be problematic in some instances, because account information received from device 1905 could have been provided by an imposter posing as human member 1910. Some embodiments, therefore, fully confirm the account information via interactions between human member 1910 and a trusted device, trusted person, or both, for example via trust link B. This might involve human member 1910 going back to the trust authority 1907 or to another location where a trusted device is available, and through which a trust relationship can be confirmed through interaction between initial account setup & trust processing module 1903 and human member 1910 via a trusted interface. Such trusted information can also be further layered in via storage in social network infrastructure 1901 and trust authority 1907. Likewise, other trust authorities could be used by human member 1910 to buttress his trust level. For example, trust authority 1909 could directly interact with trust authority 1907 for further confirmation, or to gather further trust information, e.g., “What was your mother's maiden name and where were you born?” which might not be available from trust authority 1907.

In various embodiments, once human member 1910 is established as a trusted member, he can confer trust to one or more of his “parent” devices, such as the device 1905. Device 1905 is referred to as a parent of human member 1910, because communications between social network infrastructure 1901 and human member 1910 pass through device 1905. Conferring trust from human member 1910 to device 1905 establishes another link in the trust chain, illustrated as trust link C. One way for human member 1910 to confer trust to device 1905 is by downloading one or more trusted software applications from initial account setup & trust processing module 1903 onto device 1905.

The downloaded software could analyze device 1905 for malware, security level capabilities, tampering indications, and identify of any trust servicing components such as cameras, fingerprint readers, or other biometric systems, and the like. In many instances biometrics can play an important role in verifying and maintaining trust with a device connected to a social network. For example, constant or periodic challenges and checks using biometrics, if included in a device, can allow the device to maintain a higher trust level than devices not having such biometric input. In general, the above listed security characteristics, and others, can used in making various determinations related to providing protected content.

The software can, in some embodiments, remove malware or suggest a way to repair problems via other third party software. The software can also report security threats, tampering, etc. to human member 1910 or Social network infrastructure 1901. After it has been established that device 1905 is clear of malware or other security threats, a trust level can established for the device. In some implementations, even if malware existed, device 1905 can be granted membership, but the trust level could reflect the presence of malware, and device 1905 could be red-flagged.

Once device 1905 becomes a member of the SNET, chain of trust link C can be established between human member 1910 and device 1905, now the trusted parent member 1910. In some embodiments, after device 1905 becomes a member of the SNET associated with social network infrastructure 1901, device 1905 can deliver capability, social services, control, configuration, status, etc., information to initial account setup & trust processing module 1903. Such information might indicate that 1905 is capable of servicing child human members, child device members, or only operate as a standalone device. In addition and likely in response, initial account setup & trust processing module 1903 delivers social operating program code (if not pre-loaded by the manufacturer) in the form of drivers, API's, Apps, and associated data for future use by device 1905. All of such information, along with trust information can be stored by various elements of social network infrastructure 1901. Thereafter, periodically, upon device 1905 logging in to the SNET, or otherwise, such information can be used to challenge 1905 and verify the authenticity of 1905 with some degree of trust.

At this point human member 1910 and device 1905 have received trust ratings, which may change over time as interactions and challenges occur. To add child device 1921 as a trusted member human member 1910 and device 1905 can interact to vouch for child 1921's trustworthiness. Alternatively or in addition, 1905 might assist in the process of establishing the chain of trust link D to child device 1921. Both can occur, especially wherein the device is a child device, i.e. a device that interacts with social network infrastructure 1901 only via another device. For example, child device 1921 might be a printer or a television, whereas device 1905 might be a computer or a set-top box (STB). In either case, child device 1921 may operate as a standalone device with an upstream interface to device 1905, and not directly with social network infrastructure 1901.

In such cases, child membership for child device 1921 could be established via device 1905. This can, in some embodiments, involve device 1905 retrieving and delivering to social network infrastructure 1901 information regarding child device 1921, and the link to child device 1921. It can also involve carrying out trust challenges between device 1905 and child device 1921, or between social network infrastructure 1901 and child device 1921, with bridging of such challenges via device 1905. Child device 1905 might also deliver trust program code received from initial account setup and trust processing 1903 or human member 1910, for example apps, drivers, firmware, etc., to child device 1921 to establish and maintain trust levels of child device 1921.

Device 1905 might also assist in helping child device 1921 perform better socially. For example, child device 1921 might not be a social device, but instead be designed to service only a single device 1905. With additional software running on device 1905, for example a social driver received from social network infrastructure 1901, device 1905 and members of a social network associated with social network infrastructure 1901 can gain access to status, controls, interfaces, and services offered by child device 1921. In some cases, child device 1921 can raise its trust level post facto by being taken to or otherwise directly interacting with a trusted device or authority 1923 that has a higher trust rating than that of device 1905. And even if the trust level is not higher, trusted device or authority 1923 can increase the trust level of child device 1921 because an additional, different trust chain E is used.

Similarly, although possibly contributing lesser levels of trust level or rank enhancements, other members (devices or humans) can vouch for any other member, creating another trust chain link and further bolstering the trust level of such trusted member. In various embodiments, even with a zero level of trust rating, all members could participate and thereafter build trust in the variety of ways mentioned above. Whether high or low, each member can be represented within their groups/circles with trust indicators. For example, using the rainbow (frequency sequence), the more trusted the more moving toward purple (and having a mouse over textual rating number such as 80%). The less trusted moving more toward red (for example, no trust being red) and mouse over identifies 0%. Also, based on trust levels, a social group 1931 can place limitations via per member access control and constraints 1937 on access control and other constraints. For example, in one implementation only members with 70% trust levels can gain access to “my home video”, while members with 20% trust levels can access third party video stored in a trusted NAS child member device (not shown).

For various device members of an SNET, trust can extend to malware free ratings as well as authentication. In other words, authentication can be extended to cover an authenticated service and service interactions. In other words, if a member is who it says it is, and the member does what it promises to do, the member's ratings go up. This can allow trust levels to can adapt over time, and increase or decrease as services are received or preformed. In some instances, multiple separate trust ratings and indications are used. For example, in a sales/shopping group, a “star rating” may be 5, based on a large number of satisfied member purchasers, an identity/authentication rating, i.e. “I am who I say I am,” is quite low, perhaps at 19% while operating a sales portal member server that has no independently established trust beyond that obtained from successful transactions.

In various embodiments, granting membership to device 1905 includes extending social group 1931, and can be accomplished by an icon drag and drop on a representation of social group 1931 displayed on an SNET interface (not illustrated). Once device 1905 is granted membership in social group 1931, human member 1910 can, via device 1905, add himself to a social group 1931, which can in some instances be a particular social group or sub-group, using a drag and drop procedure. Then, other member humans or devices can be added to social group 1931 in a similar manner. Furthermore, human member 1910 can alter or create a default set of rules establishing the basis for other members (human or devices) adding further members to the social group 1931.

SNET group communications in accordance with various embodiments described herein can utilize a variety of transmission protocols. By way of example, most communication over the Internet is currently performed in accordance with the Transmission Control Protocol (TCP) and User Datagram Protocol (UDP). As is known, TCP typically provides an intermediate level of communication services between, for example, an application program and the Internet Protocol (IP). Port numbers are used to identify end-points for sending and receiving applications on a host (often referred to as “Internet sockets” or “network sockets”). Internet sockets facilitate delivery of incoming data packets to an appropriate application process or thread, as determined by a combination of local and remote (e.g., SNET group) IP addresses and port numbers. In some embodiments, the Real-time Transport Protocol (RTP) running over UDP may be employed for media streaming applications, real-time multiplayer gaming, voice over IP (VoIP), and like applications that are tolerant of a certain level of packet loss and may not require a dedicated end-to-end-connection.

In some embodiments, transmissions between SNET group members and between members of different SNET groups can employ various port addressing and masking techniques to further enhance security. IDs of transmitting devices can be protected by blocking snooping of headers, use of internal IP addresses, proxies, security agents, VPN tunneling, or the like.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “operably coupled to”, “coupled to”, and/or “coupling” includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

As may also be used herein, the terms “processing module”, “module”, “processing circuit”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may have an associated memory and/or an integrated memory element, which may be a single memory device, a plurality of memory devices, and/or embedded circuitry of the processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

The present invention has been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

The present invention may have also been described, at least in part, in terms of one or more embodiments. An embodiment of the present invention is used herein to illustrate the present invention, an aspect thereof, a feature thereof, a concept thereof, and/or an example thereof. A physical embodiment of an apparatus, an article of manufacture, a machine, and/or of a process that embodies the present invention may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of the various embodiments of the present invention. A module includes a functional block that is implemented via hardware to perform one or module functions such as the processing of one or more input signals to produce one or more output signals. The hardware that implements the module may itself operate in conjunction software, and/or firmware. As used herein, a module may contain one or more sub-modules that themselves are modules. While particular combinations of various functions and features of the present invention have been expressly described herein, other combinations of these features and functions are likewise possible. The present invention is not limited by the particular examples disclosed herein and expressly incorporates these other combinations.

What is claimed is:

1. A device used with a first social networking group of a social networking system, the first social networking group having at least a first member and a second member, the device comprising:
a communication interface operable to support communication with the social networking system; and
processing circuitry, coupled to the communication interface, that is operable to:
establish participation in the first social networking group;
provide a first media related service to support a media consumption activity of the first member;
deliver status information associated with the first media related service, the status information being made available via the first social networking group to the second member; and
respond to assist in a media related activity of the second member.

2. The device of claim 2, the media related activity of the second member involving the second member interacting with the status information associated with the first media related service to initiate a media consumption activity of the second member that is related to the media consumption activity of the first member.

3. The device of claim 2, the processing circuitry operable to respond to assist in the media related activity of the second member by providing a second media related service to support a joint media consumption environment of the first member and the second member.

4. The device of claim 3, the second media related service supports a joint media consumption environment by synchronizing the media consumption activity of the first member and the media consumption activity of the second member in parallel.

5. The device of claim 4, the second media related service further supports a joint media consumption environment by adaptively transcoding at least some part of the media consumption activity of the second member.

6. The device of claim 3, the second media related service supports an acceleration process that offsets the consumption rate of the media consumption activity of the second member from the media consumption activity of the first member.

7. The device of claim 2, the status information includes supplementary information generated by the first member substantially concurrently with the media consumption activity by the first member.

8. The device of claim 7, wherein:
the supplementary information includes a marker indication associated with a portion of the media consumption activity of the first member, and
the media related activity of the second member involves the second member interacting with the marker indication to initiate a media consumption activity of the second member related to the portion of the media consumption activity of the first member.

9. The device of claim 1, the processing circuitry operable to provide a first media related service to support a media consumption activity of the first member at a second device.

10. A social networking system that supports interactions with a first social networking group, the first social networking group having a plurality of members, the social networking system comprising:
a first service that gathers and supports real-time access by the plurality of members of video consumption-related activity of each of the plurality of members; and
a second service, initiated by at least a first member of the plurality of members, that establishes a joint video consumption environment that includes the first member and a second member of the plurality of members.

11. The social networking system of claim 10, the joint video consumption environment includes a first video consumption-related activity of the first member synchronized in parallel with a second video consumption-related activity of the second member.

12. The social networking system of claim 11, each of the first video consumption-related activity of the first member and the second video consumption-related activity of the second member includes consumption of a first video content item.

13. The social networking system of claim 12, the second service supports a synchronization process that synchronizes consumption of the first video content item by the first member and the second member.

14. The social networking system of claim 12, the second service supports an acceleration process that responds to the second member consuming a different portion of the first video content item than the first member by offsetting the second member's rate of consumption of the first content item to progressively synchronize consumption of the portion of the first video content item.

15. The social networking system of claim 10, the second service is initiated by at least a first member of the plurality of members accessing an indication associated with a video consumption-related activity of the second member.

16. A device used with a first social networking group of a social networking system, the first social networking group having at least a first member and a second member, the device comprising:
a communication interface operable to support communication with the social networking system; and
processing circuitry, coupled to the communication interface, that is operable to:
provide a first video consumption-related service to support a video consumption activity of the first member;
deliver, via support from the social networking system, information relating to the video consumption activity of the first member; and
respond to assist the second member in establishing a social interaction with the first member regarding the video consumption activity of the first member.

17. The device of claim 16, the processing circuitry operable to respond to an interaction by the second member with the information to assist the second member in establishing a social interaction with the first member regarding the video consumption activity of the first member.

18. The device of claim 17, the processing circuitry operable to deliver the information to the first social networking group to be made available to the second member, the information including an indicator of a video content item being consumed, at least in part, by the first member, and an invitation to consume the video content item in parallel with the first member.

19. The device of claim 16, the processing circuitry operable to:
provide a first video consumption-related service to support a video consumption activity of the first member by providing a video content item from the second member for consumption, at least in part, by the first member, the second member is a video content source; and
deliver to the second member, via support from the social networking system, information relating to the video consumption activity of the first member, the information includes commentary, generated by the first member, related to at least a portion of the video content item.

20. The device of claim 17, the processing circuitry operable to deliver the information to the first social networking group to be made available to the second member, the information including supplementary information generated by the first member substantially concurrently with the video consumption activity of the first member.
